(19) United States
(12) Patent Application Publication
(10) Pub. No.: US 2026/0231859 A1
(43) Pub. Date: Aug. 13, 2026

(54) LAWN MOWER AND LAWN MOWING METHOD

(71) Applicant: HONDA MOTOR CO., LTD., Tokyo (JP)

(72) Inventors: Fumio Minami, Wako-shi, Saitama-ken (JP); Tatsuya Yamazaki, Wako-shi, Saitama-ken (JP); Taichi Kubota, Wako-shi, Saitama-ken (JP); Yuko Nishi, Wako-shi, Saitama-ken (JP); Shin Murakami, Wako-shi, Saitama-ken (JP); Kento Kimura, Haga-gun, Tochigi-ken (JP); Keisuke Matsubara, Wako-shi, Saitama-ken (JP); Rina Akune, Wako-shi, Saitama-ken (JP)

(21) Appl. No.: 19/155,872

(22) PCT Filed: Feb. 15, 2024
(86) PCT No.: PCT/JP2024/005373

§ 371 Date: Aug. 12, 2025

Related U.S. Application Data
(63) Continuation of application No. 18/169,421, filed on Feb. 15, 2023, now abandoned.

(51) Int. Cl. A01D 34/68; A01D 34/71; A01D 34/81; A01D 34/82; A01D 101/00

(52) U.S. Cl. CPC A01D 34/68; A01D 34/71; A01D 34/81; A01D 34/82; A01D 2101/00

(57) ABSTRACT

A lawn mower includes a cutter blade for cutting grass; a drive source that drives the cutter blade; and a housing having a blade-accommodating portion that accommodates the cutter blade, and a protruding part that protrudes from the blade-accommodating portion in a forward direction in a forward-rearward direction with respect to a travel direction and communicates with the blade-accommodating portion.

### TECHNICAL FIELD

The present invention relates to a lawn mower and a lawn mowing method.

### BACKGROUND ART

In recent years, efforts to realize a low carbon or carbon free society have been gaining momentum. Research and development in relation to electrification technology of lawn mowers are also being conducted in order to reduce CO₂ emissions and to improve energy efficiency.

In US 2020/0305345 A1, a lawn mower is disclosed. Such a lawn mower discharges grass clippings to the side or to the rear of the lawn mower.

### SUMMARY OF THE INVENTION

There has been a long awaited need for a lawn mower and a lawn mowing method that are capable of cutting grass more efficiently.

The present invention has the object of solving the aforementioned problem.

A first aspect of the present invention is characterized by a lawn mower, comprising a cutter blade configured to cut grass, a drive source configured to drive the cutter blade, and a housing including a blade accommodating portion configured to accommodate the cutter blade, and a protruding part configured to project out from the blade accommodating portion in a frontward direction in a frontward/rearward direction with respect to a traveling direction, and configured to communicate with the blade accommodating portion.

A second aspect of the present invention is characterized by a lawn mower, comprising a cutter blade configured to cut grass, a drive source configured to drive the cutter blade, a delivery unit configured to deliver grass clippings, which are pieces of the grass that has been cut, outside of a mowing range of the cutter blade, and a carry-in unit configured to carry the grass clippings that have been delivered outside of the mowing range, into the mowing range.

A third aspect of the present invention is characterized by a lawn mower, comprising a cutter blade configured to cut grass, a drive source configured to drive the cutter blade, and a delivery unit configured to cause grass clippings, which are pieces of the grass that has been cut, to be moved frontwardly of a mowing range of the cutter blade.

A fourth aspect of the present invention is characterized by a lawn mowing method, comprising a step of cutting grass using a cutter blade provided in a lawn mower, a delivering step of delivering grass clippings, which are pieces of the grass that has been cut, outside of a mowing range of the cutter blade via a delivery unit, and a step of carrying the grass clippings that have been delivered outside of the mowing range, into the mowing range by a carry-in unit.

According to the present invention, a lawn mower and a lawn mowing method are provided that are capable of cutting grass more efficiently. More specifically, the grass clippings that have been cut by the cutter blade are blown frontwardly or outside of the mowing range. As the lawn mower moves frontward, the grass clippings that have been blown outside are cut again. In this manner, by cutting the grass twice, the quality of the work, such as the appearance or the like of the lawn after the lawn mowing operation, can be improved.

### BRIEF DESCRIPTION OF DRAWINGS

FIG. 1 is a perspective view showing a lawn mower according to a first embodiment;

FIG. 2 is a bottom view of the lawn mower shown in FIG. 1;

FIG. 3 is a cross-sectional view of the lawn mower shown in FIG. 1;

FIG. 4 is a perspective view of a cutter blade;

FIG. 5 is a schematic diagram showing a configuration of the lawn mower shown in FIG. 1;

FIG. 6 is a schematic diagram showing a configuration of the lawn mower shown in FIG. 1;

FIG. 7 is a perspective view showing a cover member;

FIG. 8 FIG. 8A is a schematic diagram showing a toggle link mechanism connecting the cover member and a motor, and FIG. 8B is a schematic diagram showing the toggle link mechanism connecting the cover member and the motor;

FIG. 9 is a schematic diagram showing a flowing movement of grass clippings;

FIG. 10 is an enlarged plan view showing a protruding part and the cutter blade;

FIG. 11 is a flowchart illustrating a lawn mowing method according to the first embodiment;

FIG. 12 is a perspective view showing a lawn mower according to an Exemplary Modification 1;

FIG. 13 is a perspective view showing a lawn mower according to an Exemplary Modification 2;

FIG. 14 is a cross-sectional view of the lawn mower shown in FIG. 13;

FIG. 15 is a cross-sectional view showing a lawn mower according to an Exemplary Modification 3;

FIG. 16 is a schematic diagram showing a flowing movement of grass clippings;

FIG. 17 FIG. 17A, FIG. 17B, and FIG. 17C are schematic diagrams showing mowing of grass by the cutter blade;

FIG. 18 is a cross-sectional view showing a lawn mower according to an Exemplary Modification 4;

FIG. 19 is a bottom view of the lawn mower shown in FIG. 18;

FIG. 20 is a perspective view showing a lawn mower according to a second embodiment;

FIG. 21 is a plan view of the lawn mower shown in FIG. 20;

FIG. 22 is a side view of the lawn mower shown in FIG. 20;

FIG. 23 is a bottom view of a housing;

FIG. 24 is a cross-sectional view taken along line XXIV-XXIV of FIG. 23;

FIG. 25 is a perspective view of the housing;

FIG. 26 is a cross-sectional view showing a Comparative Example 1;

FIG. 27 is a schematic diagram showing mowing of grass according to a Comparative Example 2; and

FIG. 28 is a schematic diagram showing mowing of grass according to the second embodiment.

### DETAILED DESCRIPTION OF THE INVENTION

### First Embodiment

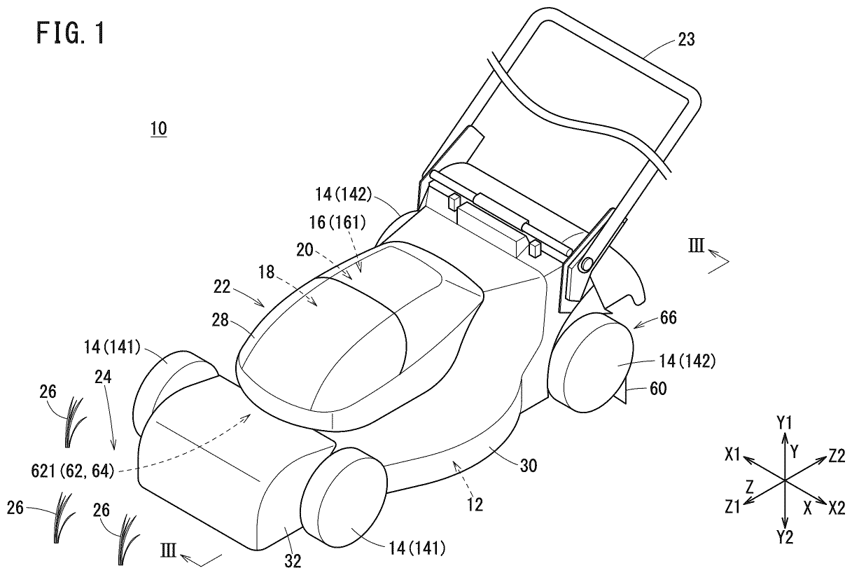

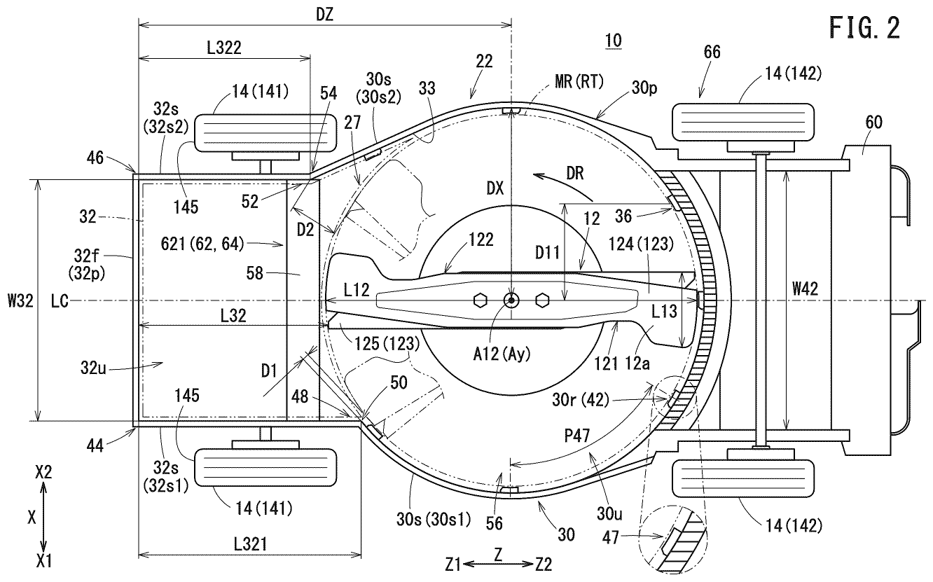

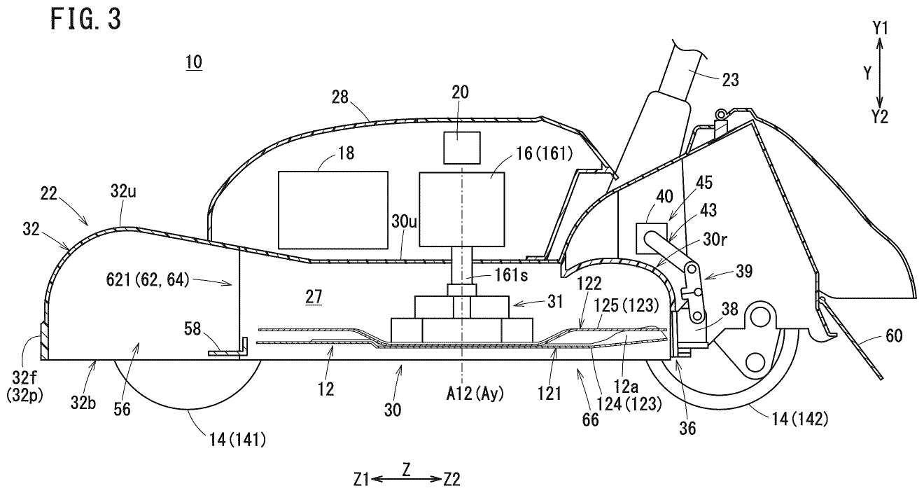

A description will be given below concerning a lawn mower 10 according to a first embodiment with reference to the drawings. FIG. 1 is a perspective view showing the lawn mower 10 according to the first embodiment. FIG. 2 is a bottom view of the lawn mower 10. FIG. 3 is a cross-sectional view of the lawn mower 10. In FIG. 3, there is shown a cross section taken along line III-III of FIG. 1.

The lawn mower 10 is a machine that cuts grass 26 using a cutter blade 12. In the first embodiment, a case will be described in which the lawn mower 10 is a rotary lawn mower, however, the lawn mower is not necessarily limited to this feature. Further, the lawn mower 10 is a walking type self-propelled working machine, however, the lawn mower is not necessarily limited to this feature. The lawn mower 10 may be a robot type working machine.

In the description that follows, pieces of the grass 26 that are cut by the lawn mower 10 will be referred to as grass clippings 34. Specifically, by rotating the cutter blade 12, the lawn mower 10 cuts the grass 26 that exists below the lawn mower 10. The lawn mower 10 also shreds, by the cutter blade 12, the grass clippings 34, which are pieces of the grass 26 that has been cut. The shredded grass clippings 34 fall to the ground by gravity or into gaps in the grass 26. The fallen grass clippings 34 decompose and become compost. This type of mowing technique is referred to as mulching. Moreover, the lawn mower 10 may also be provided with a non-illustrated grass storage body in which the grass clippings 34 are accommodated.

In the description that follows, from among the grass clippings 34, the grass clippings 34 that are inside the lawn mower 10 (grass clippings 34 prior to falling onto the ground or into gaps within the grass 26) may be referred to as grass clippings 34a. Further, the grass clippings 34 that have fallen onto the ground or into gaps within the grass 26 may be referred to as grass clippings 34b.

The lawn mower 10, as shown in FIG. 3, is equipped with the cutter blade 12, a plurality of wheels 14, a drive source 16, a battery 18, a control unit 20, a housing 22, and an operating handle 23. The cutter blade 12, the drive source 16, the battery 18, and the control unit 20 are accommodated in the housing 22. As shown in FIG. 1, the operating handle 23 extends rearwardly and obliquely upward from the housing 22.

As shown in FIG. 1 and FIG. 2, in the first embodiment, four wheels 14 (141, 142) are provided in the lawn mower 10. The four wheels 14 are made up from two front wheels 141 and two rear wheels 142. The two rear wheels 142 are drive wheels that are rotated by driving of a non-illustrated traveling motor. The two front wheels 141 are driven wheels. At a time when the operating handle 23 is grasped by a user, the two rear wheels 142 are rotated by the traveling motor and the two front wheels 141 are rotated, whereby the lawn mower 10 is capable of traveling on a traveling surface 24. Moreover, it should be noted that the number of wheels 14 provided on the lawn mower 10 is not necessarily limited to being four.

As shown in FIG. 3, the drive source 16 includes a working motor 161. The working motor 161 is a first motor for causing the cutter blade 12 to be rotatably driven. The working motor 161 is equipped with a shaft 161s. The shaft 161s extends in a downward direction Y2. The shaft 161s is rotatably driven using the battery 18. The drive source 16 further includes the aforementioned traveling motor. The traveling motor is a second motor. A shaft of the traveling motor is connected to the two rear wheels 142. The traveling motor is driven using the battery 18.

The control unit 20 is a computer that controls the lawn mower 10. The control unit 20, for example, is equipped with a processor and a memory. The memory stores a computer executable program. The processor, by executing the program that is stored by the memory, controls the lawn mower 10. For example, based on the program, the processor controls the aforementioned drive source 16. In accordance therewith, the control unit 20 is capable of causing the cutter blade 12 and the two rear wheels 142 to be driven. At least a portion of the control unit 20 may be constituted by an integrated circuit, a discrete device, or the like.

The cutter blade 12 is provided in a lower part of the lawn mower 10. The cutter blade 12 is coaxially connected to the shaft 161s.

The cutter blade 12 is driven by the working motor 161. As discussed previously, the lawn mower 10 according to the first embodiment is a so-called rotary lawn mower. Accordingly, the cutter blade 12 is a rotary blade. The cutter blade 12 rotates in response to the driving of the working motor 161. In accordance with this feature, the grass 26 that is growing on the traveling surface 24 (refer to FIG. 1) of the lawn mower 10 is cut by the cutter blade 12.

An axis of rotation A12 of the cutter blade 12 extends in an upward/downward direction Y of the lawn mower 10. The axis of rotation A12 extends along an axial line Ay that extends in the upward/downward direction Y. The upward/downward direction Y (Y1, Y2) is a direction that intersects with a frontward/rearward direction Z (Z1, Z2) of the lawn mower 10. In the frontward/rearward direction Z (Z1, Z2), a frontward direction Z1 is a traveling direction (a frontward moving direction) of the lawn mower 10. The upward/downward direction Y and the frontward/rearward direction Z are orthogonal to each other. Moreover, the axis of rotation A12 of the cutter blade 12 may be slightly inclined with respect to the axial line Ay that extends in the upward/downward direction Y.

A direction of rotation DR of the cutter blade 12 shown in FIG. 2 is determined in advance based on the orientation of the cutting edge of the cutter blade 12. As viewed from below in FIG. 2, the cutter blade 12 rotates counterclockwise. Accordingly, as viewed in plan (as viewed from above), the cutter blade 12 rotates clockwise. Moreover, the direction of rotation DR of the cutter blade 12 is not necessarily limited to the direction of the arrow shown in FIG. 2. As viewed from below in FIG. 2, the cutter blade 12 may rotate clockwise.

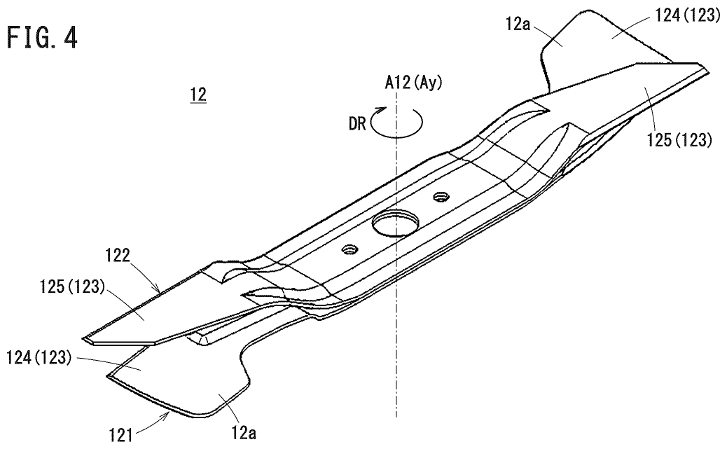

The cutter blade 12 includes a plurality of blades that rotate in response to the driving of the working motor 161. Specifically, as shown in FIG. 4, the cutter blade 12 is equipped with a first blade 121 and a second blade 122. The first blade 121 and the second blade 122 are made up, for example, from a metal (an alloy). Both of the first blade 121 and the second blade 122 extend in a direction orthogonal to the shaft 161s (refer to FIG. 3).

The first blade 121 and the second blade 122 are arranged in a manner so as to overlap in the thickness direction of the cutter blade 12 (the direction in which the shaft 161s extends). The second blade 122 overlaps in the upward direction with the first blade 121. The first blade 121 is a lower side blade. The second blade 122 is an upper side blade. Accordingly, although the second blade 122 is positioned above the first blade 121, the present embodiment is not necessarily limited to this feature.

The first blade 121 and the second blade 122 integrally rotate. Stated otherwise, the first blade 121 and the second blade 122 are arranged in a manner so as to be incapable of rotating relative to each other. Specifically, as shown in FIG. 3, an attachment portion 31 is connected to the shaft 161s of the aforementioned working motor 161. The first blade 121 and the second blade 122 are attached to the attachment portion 31 in a state in which they are overlapped with each other. The first blade 121 and the second blade 122, while being supported by the attachment portion 31, integrally rotate in response to the rotation of the shaft 161s.

As shown in FIG. 2, the rotational position of the first blade 121 in the direction of rotation DR is different from the rotational position of the second blade 122 in the direction of rotation DR. Specifically, the rotational position of the first blade 121 in the direction of rotation DR is more rearward than the rotational position of the second blade 122 in the direction of rotation DR.

As shown in FIG. 2 and FIG. 4, the first blade 121 is equipped with a first cutting portion 124 which is a cutting portion 123 for cutting the grass 26 (refer to FIG. 1). The cutter blade 12 is surrounded by a later-described peripheral wall 30p, which is provided in the housing 22. The first cutting portion 124 is provided at least in a portion of the first blade 121 that faces toward the peripheral wall 30p. Specifically, the first cutting portion 124 is provided at a distal end part of the first blade 121 in the longitudinal direction. Moreover, it should be noted that the peripheral wall 30p will be described in detail later.

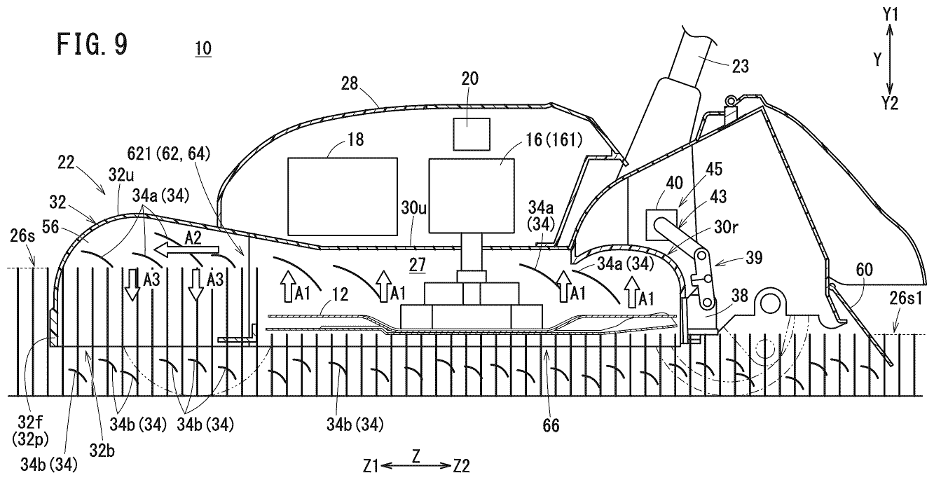

As shown in FIG. 2 to FIG. 4, the first blade 121 includes a wing portion 12a. The wing portion 12a has a surface that extends along the upward direction Y1 of the lawn mower 10 from the first blade 121. The wing portion 12a, in accordance with the rotation of the first blade 121, causes an air flow A1 (refer to FIG. 9) flowing in the upward direction Y1 to be generated. The air flow A1 causes distal end portions of the grass 26 that grows on the traveling surface 24 (refer to FIG. 1) of the lawn mower 10 to stand up vertically. Consequently, it becomes easier for the grass 26 to come into contact with the rotating cutter blade 12. More specifically, it becomes easier for the grass 26 to be cut by the cutter blade 12.

In FIG. 2 to FIG. 4, a case is shown in which the wing portion 12a is provided at one end part of the first blade 121 in the longitudinal direction. The first blade 121 may also be provided with a wing portion 12a at another end part thereof.

The second blade 122 is equipped with a second cutting portion 125 which is a cutting portion 123 for cutting the grass 26. The second cutting portion 125 is provided at least in a portion of the second blade 122 that faces toward the peripheral wall 30p. Specifically, the second cutting portion 125 is provided at a distal end part of the second blade 122 in the longitudinal direction.

In FIG. 3 and FIG. 4, the first blade 121 and the second blade 122 are formed in a stepped shape from a center portion toward distal end portions thereof. At least one of the first blade 121 or the second blade 122 may be formed in a stepped shape.

Moreover, the number of the blades provided on the cutter blade 12 is not necessarily limited to being two. The number of the blades provided on the cutter blade 12 may be one, or may be three or more.

As shown in FIG. 2 and FIG. 3, the housing 22 includes a motor housing 28 (a motor accommodating unit), a blade housing 30 (a partition member), and a protrusion housing 32 (a protruding part). In the first embodiment, a case will be described in which the motor housing 28, the blade housing 30, and the protrusion housing 32 are constituted as separate members from each other. The motor housing 28, the blade housing 30, and the protrusion housing 32 may be formed together in an integral manner. Moreover, it should be noted that the constituent material of the housing 22 is a resin or metal.

The motor housing 28 accommodates the drive source 16. The motor housing 28 further accommodates the battery 18 and the control unit 20.

The blade housing 30 is positioned below the motor housing 28. The blade housing 30 accommodates the cutter blade 12. More specifically, an inner side of the blade housing 30 is an internal space 27 (a blade accommodation space) for the purpose of accommodating the cutter blade 12. The cutter blade 12, in the internal space 27, is disposed radially inward of an inner wall 33 of the blade housing 30. Moreover, the inner wall 33 is a wall portion on the inner side of the blade housing 30. The inner wall 33 can also be considered as a surface that faces toward the inner side of the blade housing 30.

At a time when the shaft 161s is rotated, the cutter blade 12 rotates about the axis of rotation A12 without contacting the inner wall 33 of the blade housing 30. In FIG. 2, a rotation trajectory RT of an outer edge of the cutter blade 12 is shown. A portion located on the inner side of the rotation trajectory RT is a mowing range MR (a blade accommodating portion) of the cutter blade 12 for the grass 26. Stated otherwise, the mowing range MR is a spatial region in which the cutter blade 12 is disposed in the internal space 27.

As noted previously, the blade housing 30 covers a predetermined range around the periphery of the cutter blade 12. In accordance with this feature, at a time when the cutter blade 12 rotates and the grass 26 is cut, it is possible to limit the range in which the grass clippings 34 (the grass clippings 34a) scatter. The shape of the blade housing 30 when viewed from above or below is circular or is approximately circular as shown in FIG. 2, however, the present invention is not necessarily limited to this feature. The blade housing 30 includes the peripheral wall 30p, an upper wall portion 30u, and a rear part 30r (refer also to FIG. 2 and FIG. 3).

The peripheral wall 30p is a wall portion which, as viewed in plan, surrounds the cutter blade 12. An inner side of the peripheral wall 30p is the inner wall 33 of the blade housing 30. Accordingly, the inside of the peripheral wall 30p is the internal space 27.

The peripheral wall 30p extends downwardly from the upper wall portion 30u. As will be described later, an opening part 62 is formed in a front end part of the blade housing 30. A discharge port 42 (an opening part) is formed in the rear part 30r of the blade housing 30. The discharge port 42 is covered in an openable and closable manner by a cover member 38. Therefore, the peripheral wall 30p is constituted from two side wall portions 30s (30s1, 30s2) and the cover member 38. Stated otherwise, in the case that the discharge port 42 is covered by the cover member 38, the cover member 38 constitutes a part of the blade housing 30. Further, the inner walls of the two side wall portions 30s and the inner wall of the cover member 38 form the inner wall 33.

The two side wall portions 30s face toward each other in a leftward/rightward direction X (X1, X2) of the lawn mower 10. Moreover, the leftward/rightward direction X is a direction that intersects with the frontward/rearward direction Z and the upward/downward direction Y. The leftward/rightward direction X, together with being orthogonal to the frontward/rearward direction Z, is orthogonal to the upward/downward direction Y. The cutter blade 12 is disposed between the two side wall portions 30s.

As shown in FIG. 3 and FIG. 9, the lower part of the blade housing 30 is open. Accordingly, the blade housing 30 does not hinder the cutter blade 12 from contacting the grass 26 that grows on the traveling surface 24 of the lawn mower 10.

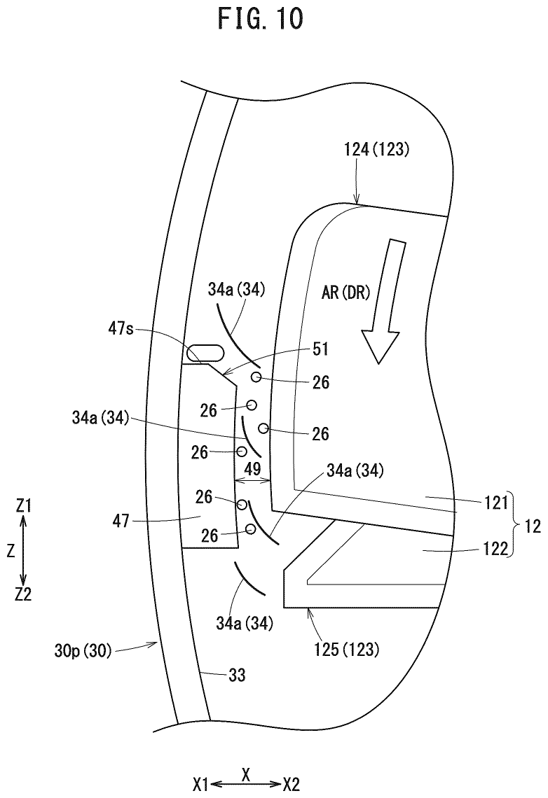

As shown in FIG. 2 and FIG. 10, the peripheral wall 30p is provided with at least one protruding part 47 (another protruding part) that projects out toward the axis of rotation A12. In the following, a case will be described in which a plurality of the protruding parts 47 are provided on the peripheral wall 30p. The plurality of protruding parts 47, as viewed in plan, are aligned along the direction of rotation DR of the cutter blade 12. The protruding parts 47 project out from the inner wall 33 of the peripheral wall 30p toward the axis of rotation A12. The inner wall 33 is a surface facing toward the direction of the axis of rotation A12. In FIG. 2, a case is illustrated in which three protruding parts 47 are provided on the inner wall of the cover member 38, and two protruding parts 47 are provided on the inner wall of each of the two side wall portions 30s (30s1, 30s2).

The protruding parts 47 are members that are made up, for example, from a resin. The protruding parts 47 project out in a direction toward the axis of rotation A12 from the protruding parts 47. The protruding parts 47 are positioned outwardly of the mowing range MR of the cutter blade 12. More specifically, the protruding parts 47 project out in the direction toward the axis of rotation A12 in a manner so as to avoid interference with the cutter blade 12. The protruding parts 47 are capable of being attached to the inner wall 33 of the peripheral wall 30p using non-illustrated screws or an adhesive, although the present invention is not necessarily limited to this feature. For example, the protruding parts 47 may be made from the same material as the peripheral wall 30p. In that case, the protruding parts 47 and the peripheral wall 30p can be formed together in an integral manner.

FIG. 10 is an enlarged view showing the protruding parts 47 and the cutter blade 12. One of the plurality of protruding parts 47 is shown in FIG. 10.

At a time when the cutter blade 12 is rotating, the protruding part 47 is capable of facing toward the cutting portions 123 (the first cutting portion 124, the second cutting portion 125) provided on the cutter blade 12. Moreover, at least one of the first cutting portion 124 or the second cutting portion 125 may face toward the protruding part 47. More specifically, at least one of the position of the first blade 121 (the first cutting portion 124) in the extending direction (the Y direction) of the axis of rotation A12 or the position of the second blade 122 (the second cutting portion 125) in the extending direction may overlap with the position of the protruding part 47 in the extending direction.

The cutting portion 123 and the protruding part 47 that face toward each other form a comparatively narrow clearance 49. More specifically, as shown in FIG. 10, the position of the protruding part 47 in the direction of rotation DR of the cutter blade 12 is capable of coinciding with the position of the cutter blade 12 in the direction of rotation DR. In that case, the clearance 49 is formed between a distal end (a protruding end) of the protruding part 47 in the protruding direction, and the distal end of the cutter blade 12 in the longitudinal direction. A dimension of the clearance 49 in the protruding direction, for example, is 2 mm to 5 mm, although the present invention is not necessarily limited to this feature.

Because the clearance 49 between the cutting portion 123 and the protruding part 47 is comparatively narrow, the grass 26 may become sandwiched between the cutting portion 123 and the protruding part 47. A force in the protruding direction can be applied to the grass 26 that is sandwiched between the cutting portion 123 and the protruding part 47. Since the cutting portion 123 moves while the force is applied in the protruding direction, the grass 26 that is sandwiched between the cutting portion 123 and the protruding part 47 can be satisfactorily cut.

Moreover, it should be noted that the peripheral wall 30p may become bent due to the external force. In the case that the peripheral wall 30p has become bent, the cutter blade 12 may come into contact with the protruding parts 47. When the rotating cutter blade 12 projects out into the protruding parts 47, there is a possibility that the cutter blade 12 may be deformed, damaged, or the like. However, as noted previously, the protruding parts 47 may be formed by a resin. The resin is softer than metal. Therefore, even in the case that the rotating cutter blade 12 comes into contact with the protruding parts 47, any risk of the cutter blade 12 being deformed, damaged, or the like can be reduced.

In order to cut the grass 26 more satisfactorily, the lawn mower 10 is provided with the structure described hereinafter.

As shown in FIG. 2, a pitch P47 between the protruding parts 47 that are adjacent to each other in the direction of rotation DR is set to be sufficiently large. The pitch P47, for example, is greater than a dimension L13 of the cutter blade 12 in the direction of rotation DR, although the present invention is not necessarily limited to this feature.

By setting the pitch P47 between the protruding parts 47 that are adjacent to each other in the direction of rotation DR to be relatively large, any risk of the grass clippings 34a becoming sandwiched and retained between the protruding parts 47 that are adjacent to each other is reduced.

As shown in FIG. 2, the direction from the protruding parts 47 toward the axis of rotation A12 may intersect with the leftward/rightward direction X of the lawn mower 10. Upon doing so, a distance (a first distance) D11 in the leftward/rightward direction X from a center line LC of the lawn mower 10 to the protruding parts 47 becomes shorter than a distance (a second distance) DX between the axis of rotation A12 and the peripheral wall 30p. In this case, the distance D11 is preferably less than or equal to 90% of the distance DX, although the present invention is not necessarily limited to this feature. The center line LC is an imaginary straight line that passes through the axis of rotation A12 and is parallel to the frontward/rearward direction Z.

As shown in FIG. 2, at least one of the plurality of protruding parts 47 is disposed frontwardly of the axis of rotation A12. In accordance with this feature, it is easier for the grass clippings 34a that fall downwardly of the protruding part 47 to be cut by the cutter blade 12. More specifically, by the cutter blade 12 being rotated, an air flow (a rotating air flow) AR flowing in the direction of rotation DR can be generated inside of the peripheral wall 30p. Due to the rotating air flow AR, the grass clippings 34a can be made to flow in the direction of rotation DR inside the peripheral wall 30p. At a time when the grass clippings 34a are flowing in the direction of rotation DR, there are cases in which they collide with the protruding parts 47 and fall down. The grass clippings 34a that have collided with the protruding parts 47 that are positioned more frontwardly than the axis of rotation A12 can fall frontwardly of the axis of rotation A12 (the cutter blade 12). Since the lawn mower 10 moves forward, the grass clippings 34a that have fallen frontwardly of the axis of rotation A12 are cut again by the cutter blade 12.

The protruding amount of each of the plurality of protruding parts 47 in the protruding direction may be changed in accordance with the distance D11 between the center line LC and the protruding part 47 in the leftward/rightward direction X. Specifically, concerning the protruding parts 47 whose distance D11 from the center line LC in the leftward/rightward direction X is relatively short, the protruding amount thereof in the protruding direction is made small. Concerning the protruding parts 47 whose distance D11 from the center line LC in the leftward/rightward direction X is relatively long, the protruding amount thereof in the protruding direction is made large.

In accordance with this feature, the grass 26 is easily cut at the protruding parts 47 whose protruding amount is comparatively large. Further, the grass 26 is difficult to cut at the protruding parts 47 whose protruding amount is comparatively small. As a result, the amount of the grass clippings 34a that fall downwardly of the protruding parts 47 whose distance D11 from the center line LC is comparatively large can be suppressed compared to the amount of the grass clippings 34a that fall downwardly of the protruding parts 47 whose distance D11 from the center line LC is comparatively small.

The protruding parts 47 are each equipped with an inclined portion 51 (an inclined surface) that is inclined with respect to the protruding direction of the protruding parts 47. The protruding parts 47 each include a side part 47s. The side parts 47s are disposed on rear sides of the protruding parts 47 in the direction of rotation DR. The inclined portion 51, which is inclined with respect to the protruding direction of the protruding parts 47, is formed on the side part 47s. The inclined portion 51 may be formed over the entire side part 47s, or the inclined portion 51 may be formed at only one part of the side part 47s. The inclined portion 51 is inclined along the direction of rotation DR with respect to the protruding direction. Stated otherwise, the inclined portion 51 is inclined along the protruding direction with respect to the direction of rotation DR.

The grass clippings 34a can flow along the inclined portion 51. The inclined portion 51 is inclined in a manner so that the grass clippings 34a flow toward the protruding end of the protruding part 47. Since the protruding part 47 is formed with the inclined portion 51, the grass clippings 34a are capable of being guided along the inclined portion 51. The grass clippings 34a which are guided by the inclined portion 51 can be shredded by the cutting portion 123.

As noted previously, the rotational position of the first blade 121 in the direction of rotation DR is more rearward than the rotational position of the second blade 122 in the direction of rotation DR. Therefore, after the grass clippings 34a have been guided to the protruding end of the protruding part 47 by the rotating air flow AR generated by the second blade 122, the protruding end and the first cutting portion 124 of the first blade 121 face toward each other. As a result, the grass clippings 34a that are guided to the protruding end of the protruding part 47 are more likely to become shredded by the first cutting portion 124 provided on the first blade 121.

As shown in FIG. 3, the upper wall portion 30u is positioned above the cutter blade 12. According to the first embodiment, although the upper wall portion 30u serves in a dual manner as a bottom portion of the motor housing 28, the present embodiment is not necessarily limited to this feature. The aforementioned shaft 161s passes through the upper wall portion 30u, and is connected to the cutter blade 12. The shaft 161s and the cutter blade 12 are connected via the attachment portion 31. The upper wall portion 30u connects the two side wall portions 30s and the rear part 30r. Moreover, the two side wall portions 30s, the rear part 30r, and the upper wall portion 30u may be formed together in an integral manner.

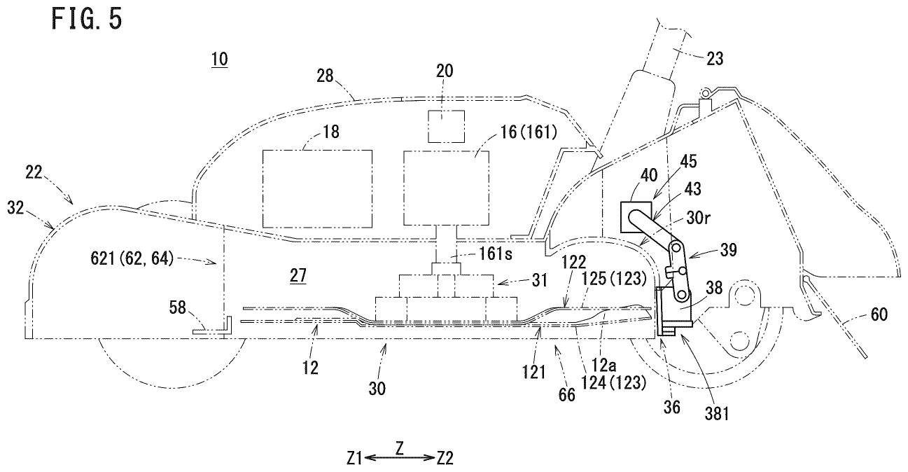

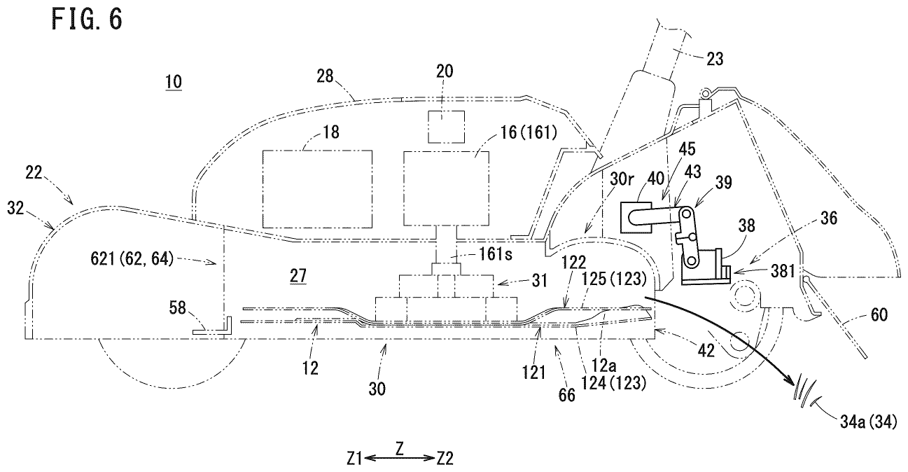

Each of FIG. 5 and FIG. 6 is a side view of the lawn mower 10.

A discharge unit 36 is provided at the rear part 30r of the blade housing 30. The discharge unit 36 includes the cover member 38 and an actuator 45. The actuator 45 includes a toggle link mechanism 39, and a motor 40. The discharge port 42 is formed in the rear part 30r of the blade housing 30. The grass clippings 34a are discharged rearwardly through the discharge port 42.

It is preferable that a width W42, which is the dimension of the discharge port 42 (the discharge unit 36) in the leftward/rightward direction X, is comparatively large. Specifically, it is preferable that the width W42 be greater than or equal to one half of the mowing range of the cutter blade 12 in the leftward/rightward direction X. More specifically, it is preferable that the width W42 be greater than or equal to one half of a dimension L12 of the cutter blade 12 in the longitudinal direction. By setting the width W42 to be comparatively large in this manner, the grass clippings 34a can easily pass through the discharge port 42.

The width W42, which is the dimension of the discharge port 42 in the leftward/rightward direction X, is greater than a width W32, which is the dimension of the protrusion housing 32 in the leftward/rightward direction X (refer also to FIG. 2). Moreover, it should be noted that the width W32 is the maximum dimension of the protrusion housing 32. The actual dimension of the protrusion housing 32 in the leftward/rightward direction X may differ from the width W32.

Further, the discharge port 42 is preferably positioned between the two wheels 14 (the rear wheels 142). In accordance with this feature, the lawn mower 10 can be constituted in a compact manner.

The cover member 38 covers the discharge port 42 in an openable and closable manner. Accordingly, the discharge unit 36 includes the cover member 38 and the discharge port 42. The cover member 38 is curved in accordance with the rotation trajectory RT of the cutter blade 12 (refer to FIG. 2). More specifically, an inner surface (an inner wall) of the cover member 38 is formed along the rotation trajectory RT. The surface of such a cover member 38 includes an arc that constitutes a part of an imaginary circle centered on the axis of rotation A12. In accordance with this feature, any risk of the grass clippings 34a that flow inside the blade housing 30 becoming stuck between the blade housing 30 and the cover member 38 can be reduced.

In the case that the cover member 38 is in a closed state, the inner wall of the cover member 38 and the inner walls of the two side wall portions 30s (30s1, 30s2) are flush with each other (refer to FIG. 2). More specifically, the cover member 38 does not project out toward the inner side with respect to the two side wall portions 30s (30s1, 30s2). In accordance with this feature, any risk of the grass clippings 34a that flow inside the blade housing 30 becoming stuck between the two side wall portions 30s (30s1, 30s2) and the cover member 38 can be further reduced.

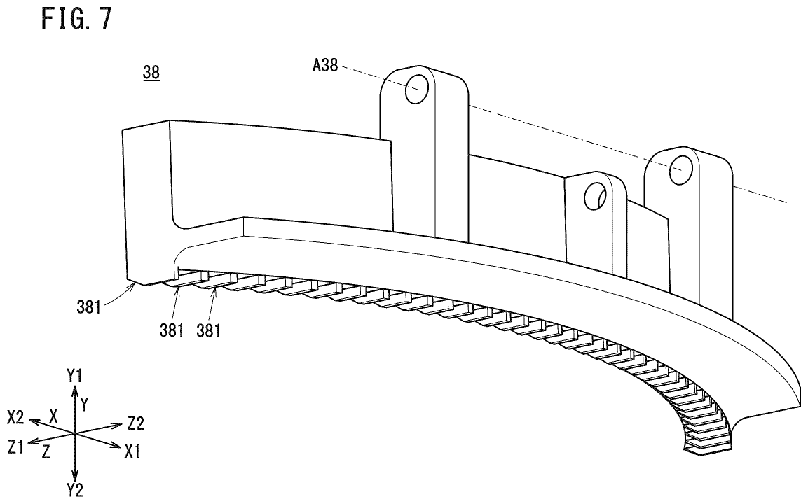

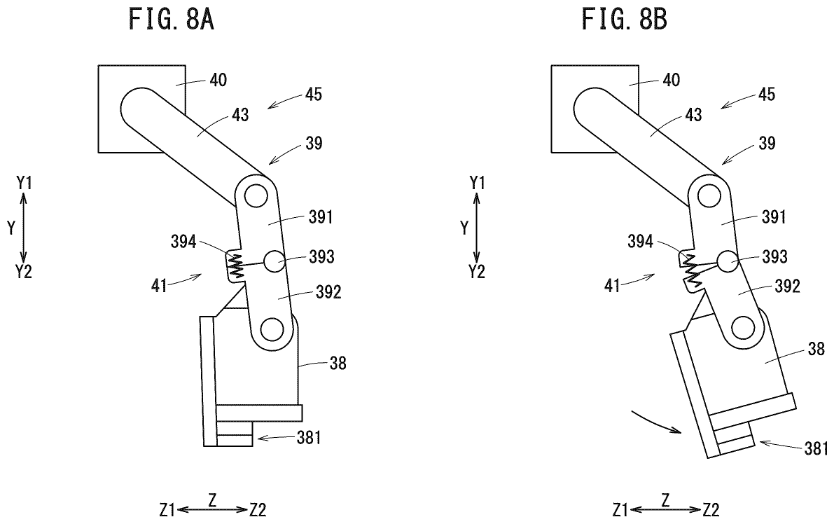

As shown in FIG. 7 to FIG. 8B, the motor 40 is connected to the cover member 38 via the toggle link mechanism 39. The cover member 38, in response to driving of the motor 40, rotates about an axis of rotation A38 that extends in the leftward/rightward direction X of the lawn mower 10. A degree of opening of the cover member 38 changes in accordance with an amount by which the motor 40 is driven. Moreover, the motor 40 is capable of being controlled by the aforementioned control unit 20 (refer to FIG. 3). A more detailed description of the control unit 20 will be given later.

In FIG. 3 and FIG. 5, a closed state of the cover member 38 is shown. As shown in FIG. 7, a plurality of protruding parts 381 are provided on the cover member 38. The plurality of protruding parts 381 are aligned at an interval from one another along the leftward/rightward direction X. Further, in the case that the cover member 38 is in a closed state, the plurality of protruding parts 381 project out downwardly from the cover member 38.

The plurality of protruding parts 381 that project out downwardly are capable of combing the grass 26 at a time when the lawn mower 10 is moving forward. In accordance with this feature, the appearance of a grass surface 26s1 (refer also to FIG. 9) after the lawn mower 10 has mowed the grass can be improved.

The protruding parts 381 preferably extend in the frontward/rearward direction Z. By the dimension of the protruding parts 381 in the frontward/rearward direction Z being comparatively large, the grass 26 can be combed more satisfactorily accompanying the forward movement of the lawn mower 10.

The lawn mower 10 in a state in which the cover member 38 is open is shown in FIG. 6. When the lawn mower 10 in the state in which the cover member 38 is open moves forward, the grass clippings 34a inside the blade housing 30 are discharged in a rearward direction Z2 via the discharge port 42. As the degree of opening of the cover member 38 becomes greater, the amount of the grass clippings 34a that are discharged becomes more plentiful.

The load that is applied to the cutter blade 12, at a time when a target object to be cut such as the grass 26, the grass clippings 34a, or the like is cut, is a resistance force that the cutter blade 12 receives from the target object to be cut. As the amount of the target object to be cut that remains inside the blade housing 30 becomes greater, the load can become greater. By the grass clippings 34a inside the blade housing 30 being discharged, the load applied to the cutter blade 12 can be reduced.

By reducing the load applied to the cutter blade 12, the electrical power consumption of the working motor 161 can be suppressed. In accordance with this feature, the electrical power consumption of the lawn mower 10 can be suppressed.

The actuator 45 is controlled by the above-described control unit 20. The control unit 20, by controlling the actuator 45, is capable of causing the degree of opening of the cover member 38 to be changed in a manner so that an excessive load is not applied to the cutter blade 12.

The control unit 20 changes the degree of opening of the cover member 38 based on, for example, information indicating the load applied to the cutter blade 12. More specifically, for example, in the case that the load applied to the cutter blade 12 is less than a predetermined load threshold value, the control unit 20 sets the degree of opening of the cover member 38 to zero. In other words, for example, in the case that the load applied to the cutter blade 12 is less than the predetermined load threshold value, the control unit 20 closes the cover member 38. In the case that the load applied to the cutter blade 12 has become greater than or equal to the predetermined load threshold value, the control unit 20 makes the degree of opening of the cover member 38 greater than zero. In other words, in the case that the load applied to the cutter blade 12 has become greater than or equal to the predetermined load threshold value, the control unit 20 opens the cover member 38. The control unit 20 may set the degree of opening of the cover member 38 to a degree of opening corresponding to the load applied to the cutter blade 12.

The information indicating the load applied to the cutter blade 12, for example, is a value of the electrical current supplied to the working motor 161, although the present invention is not necessarily limited to this feature. The value of the electrical current supplied to the working motor 161 is detected using a sensor such as an electrical current sensor or the like.

Moreover, it should be noted that the load applied to the cutter blade 12 in the case that the grass 26 is wet is greater than the load applied to the cutter blade 12 in the case that the grass 26 is dry. As the grass 26 becomes longer, the load that is applied to the cutter blade 12 becomes greater. As the moving speed of the lawn mower 10 becomes greater, the load that is applied to the cutter blade 12 becomes greater. Taking these factors into consideration, the control unit 20 may determine the degree of opening of the cover member 38 based on information indicating at least one of the wetness of the grass 26, the length of the grass 26, the moving speed of the lawn mower 10, the weather, the air temperature, or the humidity. Specifically, in the case that the grass 26 is wet, in the case that the grass 26 is relatively long, or in the case that the moving speed of the lawn mower 10 is high, the degree of opening of the cover member 38 is set to be large.

The information indicating at least one of the wetness of the grass 26, the length of the grass 26, the moving speed of the lawn mower 10, the weather, the air temperature, or the humidity can be input by the user to the control unit 20, although the present invention is not necessarily limited to this feature. This information may be input to the control unit 20 as appropriate via a non-illustrated communication device that is provided in the lawn mower 10. The wetness of the grass 26 and the humidity may be detected by a non-illustrated humidity sensor. The air temperature may be detected by a non-illustrated air temperature sensor. The moving speed of the lawn mower 10 may be acquired by a non-illustrated speed sensor that is provided in the lawn mower 10. The length of the grass 26 may be detected by an image recognition process in which an image of the grass 26 is used. The image of the grass 26 can be acquired, for example, by a non-illustrated camera that is provided on the lawn mower 10.

In the case that the amount of change per unit time of the load applied to the cutter blade 12 has exceeded a predetermined amount, the control unit 20 may control the motor 40 so as to increase the degree of opening of the cover member 38. In accordance with this feature, in the case that the load applied to the cutter blade 12 has increased, it is possible to suitably reduce the load.

Further, the control unit 20 may determine the degree of opening of the cover member 38 based on information indicating a residual charge of the battery 18. The control unit 20, for example, in the case that the residual charge of the battery 18 has become less than or equal to a predetermined residual charge threshold value, controls the motor 40 and thereby opens the cover member 38. In accordance with this feature, it is possible to suppress the speed at which the residual charge of the battery 18 decreases. The control unit 20 may set the degree of opening of the cover member 38 to a degree of opening corresponding to the residual charge of the battery 18. For example, as the residual charge of the battery 18 decreases, the control unit 20 may increase the degree of opening of the cover member 38. The information indicating the residual charge of the battery 18 is acquired, for example, using a non-illustrated voltage sensor provided on the battery 18, although the present invention is not necessarily limited to this feature.

Each of FIG. 8A and FIG. 8B is a schematic diagram showing the toggle link mechanism 39 connecting the cover member 38 and the motor 40.

As noted previously, the cover member 38 and the motor 40 are connected via the toggle link mechanism 39. The toggle link mechanism 39 is equipped with a first link member 391, a second link member 392, a connecting shaft member 393, and a tension biasing member 394. The tension biasing member 394, for example, is a tension spring, although the present invention is not necessarily limited to this feature.

One end of the first link member 391 is connected via a transmission member 43 to the motor 40. Another end of the first link member 391 is connected to the connecting shaft member 393 and the tension biasing member 394. The connecting shaft member 393 is positioned rearwardly of the tension biasing member 394.

One end of the second link member 392 is connected to the cover member 38. Further, another end of the second link member 392 is connected to the connecting shaft member 393 and the tension biasing member 394.

The second link member 392 is capable of rotating about the connecting shaft member 393 with respect to the first link member 391. The tension biasing member 394 applies a tensile force to the first link member 391 and the second link member 392. In accordance with this feature, the rotation of the second link member 392 about the connecting shaft member 393 with respect to the first link member 391 is suppressed.

Such a toggle link mechanism 39 is capable of functioning as a release mechanism 41 that releases the closed state of the cover member 38 in the case that an excessive load is applied to the cover member 38 in the closed state. More specifically, at a time when the lawn mower 10 is moving, there may be cases in which the cover member 38 comes into contact with an obstacle that is positioned frontwardly of the cover member 38. The obstacle, for example, is a stone or a rock. When the lawn mower 10 moves forward in a state in which the obstacle abuts against the front surface of the cover member 38 in the closed state, an external force in the rearward direction Z2 is applied to the cover member 38. In response to the external force, the second link member 392 rotates about the connecting shaft member 393. Since such a toggle link mechanism 39 is provided, in the case that the obstacle abuts against the cover member 38, the cover member 38 can be opened without causing the motor 40 to be driven (refer also to FIG. 8B). Stated otherwise, in response to the external force in the rearward direction Z2 being applied from the obstacle, the closed state of the cover member 38 can be released. In accordance with this feature, any risk of the cover member 38 being damaged, deformed, or the like due to coming into contact with the obstacle can be reduced.

Moreover, when the lawn mower 10 moves forward and the cover member 38 is positioned frontwardly of the obstacle, the second link member 392 can be returned to its original state due to the tensile force applied from the aforementioned tension biasing member 394 (refer also to FIG. 8A). More specifically, since such a toggle link mechanism 39 is provided, in the case that the cover member 38 is positioned frontwardly of the obstacle, the cover member 38 can be returned to the closed state without driving the motor 40.

As shown in FIG. 2 and FIG. 3, the protrusion housing 32 projects out in the frontward direction Z1 from the blade housing 30. The protrusion housing 32 includes two side wall portions 32s (32s1, 32s2), a front wall portion 32f, and an upper wall portion 32u. The two side wall portions 32s are made up from a first side wall portion 32s1 and a second side wall portion 32s2. The front wall portion 32f includes a protruding end 32p (a front end) of the protrusion housing 32. The shape of the protrusion housing 32 as viewed in plan (as viewed from above) is a substantially rectangular shape, however, the present invention is not necessarily limited to this feature. A lower part 32b of the protrusion housing 32 is open.

In FIG. 2, a range of the protrusion housing 32 is illustrated by a two-dot dashed line. The protrusion housing 32 is a portion of the housing 22 that projects out more frontwardly than the rotation trajectory RT of the cutter blade 12. A rear end side of the protrusion housing 32 is shaped in a manner so as to fit along the front part of the rotation trajectory RT. Moreover, in FIG. 2, an inner side of a wall portion that projects out in the frontward direction Z1 from the blade housing 30 is illustrated by the two-dot dashed line as the protrusion housing 32. In the first embodiment, the wall portion that projects out in the frontward direction Z1 from the blade housing 30 may be included in the protrusion housing 32.

The protruding end 32p of the protrusion housing 32 is disposed more frontwardly than each of front ends 145 of the pair of front wheels 141.

The first side wall portion 32s1 and the second side wall portion 32s2 face toward each other in the leftward/rightward direction X and extend along the frontward direction Z1. The first side wall portion 32s1 is positioned on one side of the center line LC of the lawn mower 10. The second side wall portion 32s2 is positioned on another side of the center line LC of the lawn mower 10. The center line LC is an imaginary straight line that extends in parallel with the frontward/rearward direction Z and intersects with the axis of rotation A12 of the cutter blade 12. A front end 44 of the first side wall portion 32s1, and a front end 46 of the second side wall portion 32s2 are connected to the front wall portion 32f. A rear end 48 of the first side wall portion 32s1 is connected to a front end 50 of the side wall portion 30s1 of the blade housing 30. A rear end 52 of the second side wall portion 32s2 is connected to a front end 54 of the side wall portion 30s2 of the blade housing 30.

In the direction of rotation DR of the cutter blade 12, which will be described hereinafter, the second side wall portion 32s2 is a side wall portion from which the cutter blade 12 rotates. Further, in the direction of rotation DR, the first side wall portion 32s1 is a side wall portion that is further forward in rotation than the second side wall portion 32s2. The term further forward in rotation refers to the front side in the direction of rotation DR.

The upper wall portion 32u is connected to the first side wall portion 32s1, the second side wall portion 32s2, the front wall portion 32f, and the upper wall portion 30u of the blade housing 30.

FIG. 9 is a schematic diagram showing a flowing movement of the grass clippings 34a.

The aforementioned protrusion housing 32 communicates with the blade housing 30. More specifically, the opening part 62 (a first opening part 621) is formed on the front end part of the blade housing 30. Via the first opening part 621, the blade housing 30 and the protrusion housing 32 communicate with each other. A single space 56 is constituted by the blade housing 30 and the protrusion housing 32.

At a time when the cutter blade 12 rotates in the direction of rotation DR, the above-described air flow A1 flowing in the upward direction Y1 is generated inside the space 56 by the wing portion 12a. At this time, the cutter blade 12 cuts the grass 26 while rotating in the direction of rotation DR. In accordance therewith, the grass clippings 34a are generated.

The air flow A1 collides with the upper wall portion 30u of the blade housing 30, and thereby becomes an air flow A2 flowing in the frontward direction Z1. Due to the air flow A2, the grass clippings 34a that are cut by the cutter blade 12 flow from the blade housing 30 into the protrusion housing 32. Specifically, the grass clippings 34a, via the first opening part 621, are delivered outside of the mowing range MR of the cutter blade 12 (refer to FIG. 2). More specifically, via the first opening part 621, the grass clippings 34a are delivered frontwardly of the blade housing 30.

The air flow A2 collides with the front wall portion 32f or the side wall portions 32s, and thereby becomes an air flow A3 flowing in the downward direction Y2. As noted previously, the lower part 32b of the protrusion housing 32 is open. Therefore, the grass clippings 34a inside the protrusion housing 32, due to the air flow A3, fall down onto a grass surface 26s in front of the cutter blade 12.

At this time, the grass clippings 34a that have not been sufficiently finely shredded adhere to the grass surface 26s prior to being cut, inside the protrusion housing 32. When the lawn mower 10 moves forward, the grass clippings 34a that adhere to the grass surface 26s inside the protrusion housing 32 are cut again by the cutter blade 12. Consequently, the grass clippings 34a that have adhered to the grass surface 26s are more finely shredded.

The grass clippings 34a that have been sufficiently finely shredded by the cutter blade 12 can pass over the grass surface 26s, and fall downwardly of the grass surface 26s as the grass clippings 34b. The grass clippings 34b that have entered downwardly of the grass surface 26s are less noticeable. Therefore, the beauty of the grass surface 26s1 after the grass 26 has been cut is not impaired.

In this manner, according to the first embodiment, the grass clippings 34a are delivered frontwardly of the mowing range MR of the cutter blade 12. Accordingly, simply by being made to move forward while the cutter blade 12 is being driven, the lawn mower 10 can continue to shred the grass clippings 34a, until the grass clippings 34a are capable of entering downwardly of the grass surface 26s as the grass clippings 34b. Therefore, after the lawn mower 10 has passed over the grass surface 26s1, the grass clippings 34a are less likely to remain thereon.

Stated otherwise, the aforementioned lawn mower 10 is equipped with a delivery unit 64 and a carry-in unit 66. The delivery unit 64 delivers the grass clippings 34a outside of the mowing range MR of the cutter blade 12. The aforementioned first opening part 621 is included in the delivery unit 64. By the grass clippings 34a being delivered outside of the mowing range MR, the amount of the grass clippings 34a that remain inside the blade housing 30 is suppressed. As a result, an increase in the load that is applied to the cutter blade 12 is suppressed. Moreover, as noted previously, the grass clippings 34a are caused to move by the air flows (A1 and A2) generated by the cutter blade 12. Stated otherwise, the delivery unit 64 is capable of using the air flows (A1 and A2) that are generated by the cutter blade 12, and thereby delivering the grass clippings 34a. More specifically, by making use of a difference between the air pressure inside the blade housing 30, from which the grass clippings 34a are delivered, and the air pressure outside of the blade housing 30, to which the grass clippings 34a are delivered, the delivery unit 64 is capable of delivering the grass clippings 34a. The carry-in unit 66 is capable of carrying the grass clippings 34a that have been delivered outside of the mowing range MR, into the mowing range MR. The carry-in unit 66 can include the plurality of wheels 14 that cause the lawn mower 10 to move forward, and an opening formed in the lower part of the blade housing 30. The lawn mower 10 is capable of finely cutting the grass clippings 34a that have been carried into the mowing range MR.

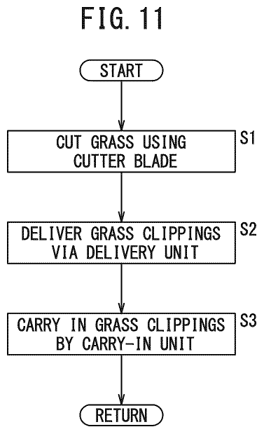

FIG. 11 is a flowchart illustrating a lawn mowing method according to a first embodiment.

The above-described lawn mower 10 is capable of carrying out the lawn mowing method shown in FIG. 11. More specifically, the lawn mower 10 (refer to FIG. 1 to FIG. 6) is capable of cutting the grass 26 using the cutter blade 12 (step S1).

Further, the lawn mower 10 is capable of delivering the grass clippings 34a, via the delivery unit 64, outside of the mowing range MR of the cutter blade 12 (step S2). Furthermore, by the carry-in unit 66, the lawn mower 10 is capable of carrying the grass clippings 34a, which have been delivered outside of the mowing range MR, into the mowing range MR (step S3). These steps S1 to S3 are executed in parallel at the same time. In accordance with such features, the lawn mower 10 is capable of finely cutting the grass clippings 34a, while suppressing an increase in the load applied to the cutter blade 12. The lawn mower 10, by moving forward while rotating the cutter blade 12, is capable of repeatedly executing steps S1 to S3 shown in FIG. 11. The aforementioned control unit 20 may automatically execute steps S1 to S3 shown in FIG. 11 based on the program.

Moreover, in order to cut the grass 26 more efficiently, the lawn mower 10 is provided with the structure described hereinafter.

As shown in FIG. 2, the distance between the first side wall portion 32s1 and the second side wall portion 32s2 is smaller than the dimension L12 of the cutter blade 12 in the longitudinal direction. More specifically, the width (the inner width) W32, which is the dimension of the protrusion housing 32 in the leftward/rightward direction X, is smaller than the dimension L12 of the cutter blade 12 in the longitudinal direction (W32<L12). By doing so, the grass clippings 34a that fall down onto the grass surface 26s (refer to FIG. 6) inside the protrusion housing 32 can be reliably positioned within the mowing range of the cutter blade 12.

A dimension L321 of the first side wall portion 32s1 in the frontward/rearward direction Z is longer than a dimension L322 of the second side wall portion 32s2 in the frontward/rearward direction Z (L321>L322). The position of the rear end 48 of the first side wall portion 32s1 in the frontward/rearward direction Z is positioned more rearwardly than the position of the rear end 52 of the second side wall portion 32s2 in the frontward/rearward direction Z. By doing so, a larger amount of the grass clippings 34a can be received by the first side wall portion 32s1. By causing the grass clippings 34 to collide with the first side wall portion 32s1, the grass clippings 34a can be more reliably made to fall. Further, the second side wall portion 32s2 becomes less likely to hinder the flow of the grass clippings 34a toward the first side wall portion 32s1. Moreover, the dimension L321 is the maximum dimension of the first side wall portion 32s1. The actual dimension of the first side wall portion 32s1 in the frontward/rearward direction Z may differ from the dimension L321.

In a state in which the longitudinal direction of the cutter blade 12 coincides with the frontward/rearward direction Z, the rear end 48 of the first side wall portion 32s1 and a part of the cutter blade 12 overlap as viewed from the side. On the other hand, even in the state in which the longitudinal direction of the cutter blade 12 coincides with the frontward/rearward direction Z, the rear end 52 of the second side wall portion 32s2 and the cutter blade 12 do not overlap as viewed from the side. By doing so, the first side wall portion 32s1 and the grass clippings 34 are more likely to collide with each other. Further, the second side wall portion 32s2 becomes less likely to hinder the flow of the grass clippings 34a toward the first side wall portion 32s1. Moreover, the longitudinal direction of the cutter blade 12 in FIG. 2 coincides with the frontward/rearward direction Z.

The distance between the cutter blade 12 and the rear end 48 of the first side wall portion 32s1 at a time at which the cutter blade 12 and the rear end 48 of the first side wall portion 32s1 are in closest proximity to each other is defined as a first distance D1. The distance between the cutter blade 12 and the rear end 52 of the second side wall portion 32s2 at a time at which the cutter blade 12 and the rear end 52 of the second side wall portion 32s2 are in closest proximity to each other is defined as a second distance D2. The second distance D2 is greater than the first distance D1 (D2>D1). By doing so, the second side wall portion 32s2 becomes less likely to hinder the flow of the grass clippings 34a toward the first side wall portion 32s1.

A distance DZ in the frontward/rearward direction Z between the axis of rotation A12 of the cutter blade 12 and the protruding end 32p of the protrusion housing 32 is greater than the distance DX in the leftward/rightward direction X between the axis of rotation A12 and the inner wall of the blade housing 30 (DZ>DX). In accordance with this feature, the protrusion housing 32 is capable of accommodating a large amount of the grass clippings 34a. As a result, the amount of the grass clippings 34a that remain inside the blade housing 30 is suppressed. By the amount of the grass clippings 34a that remain inside the blade housing 30 being suppressed, the load applied to the cutter blade 12 is also suppressed. By the load applied to the cutter blade 12 being suppressed, the electrical power consumption of the lawn mower 10 is also suppressed.

It is preferable that a protruding length L32 (a dimension) of the protrusion housing 32 is greater than or equal to one third of the dimension L12 of the cutter blade 12 in the longitudinal direction (L32≥L12/3). It is preferable that the protruding length L32 of the protrusion housing 32 is greater than or equal to one half of the dimension L12 of the cutter blade 12 in the longitudinal direction (L32≥L12/2). In accordance therewith, the protrusion housing 32 is capable of accommodating a larger amount of the grass clippings 34a. Moreover, the protruding length L32 of the protrusion housing 32 is a distance in the frontward/rearward direction Z between a front end of the cutter blade 12 and the protruding end 32p of the protrusion housing 32 in a state in which the longitudinal direction of the cutter blade 12 coincides with the frontward/rearward direction Z. Moreover, the protruding length L32 is the maximum dimension of the protrusion housing 32. The actual dimension of the protrusion housing 32 in the frontward/rearward direction Z may differ from the protruding length L32.

In the case that the protrusion housing 32 is not provided on the housing 22, the amount of the grass clippings 34a that remain inside the blade housing 30 is likely to increase. Therefore, in the case that the protrusion housing 32 is not provided on the housing 22, the load applied to the cutter blade 12 is likely to increase. Accordingly, in the case that the protrusion housing 32 is not provided on the housing 22, the electrical power consumption of the lawn mower 10 is likely to become very high.

In contrast thereto, in the first embodiment, the grass clippings 34a flow from the blade housing 30 into the protrusion housing 32. In accordance with this feature, in the first embodiment, the amount of the grass clippings 34a that remain inside the blade housing 30 can be suppressed. Therefore, according to the first embodiment, the electrical power consumption of the lawn mower 10 can be suppressed.

Further, in the first embodiment, the grass clippings 34a that have been sufficiently finely shredded fall more downwardly than the grass surface 26s. The grass clippings 34a (or the grass clippings 34b) that have fallen more downwardly than the grass surface 26s are unlikely to come into contact with the cutter blade 12. Stated otherwise, the grass clippings 34b that have fallen more downwardly than the grass surface 26s are less likely to impart a load to the cutter blade 12. Therefore, according to the first embodiment, the electrical power consumption of the lawn mower 10 can be suppressed.

In addition, as discussed previously, the lawn mower 10 according to the first embodiment is equipped with the discharge unit 36. In the case that the load on the cutter blade 12 has increased to a certain level, the cover member 38 is opened by the control unit 20. Consequently, the grass clippings 34a are discharged rearwardly of the lawn mower 10 from the blade housing 30, and the load on the cutter blade 12 can be thereby reduced. More specifically, the electrical power consumption of the lawn mower 10 can be suppressed.

The lawn mower 10 is further equipped with a rib 58 and a grass dropping tool 60.

The rib 58 is a member that extends in the leftward/rightward direction X, and connects the first side wall portion 32s1 and the second side wall portion 32s2 of the protrusion housing 32. The first side wall portion 32s1 and the second side wall portion 32s2 are connected by the rib 58, and thereby bending of the protrusion housing 32 is suppressed.

The grass dropping tool 60 is disposed rearwardly of the housing 22. The grass dropping tool 60, for example, includes a plate-shaped member or a brush member. The grass dropping tool 60 shown in FIG. 3 includes a plate-shaped member. The grass dropping tool 60 causes the grass clippings 34a, which adhere to the grass surface 26s1 after mowing of the grass, to fall downwardly from the grass surface 26s1. In accordance with this feature, the grass surface 26s1 after mowing of the grass can be put in order. Moreover, the grass dropping tool 60 may be an air blower or the like. In this case as well, the grass clippings 34a can appropriately be made to drop down after mowing of the grass.

The above-described first embodiment may be modified in the following manner. In the exemplary modifications described below, descriptions that overlap or are duplicative of those in the first embodiment will be omitted. Further, in the drawings that are used in the exemplary modifications described below, the same reference numerals are used to designate the same constituent elements as those described in the first embodiment.

### (Exemplary Modification 1)

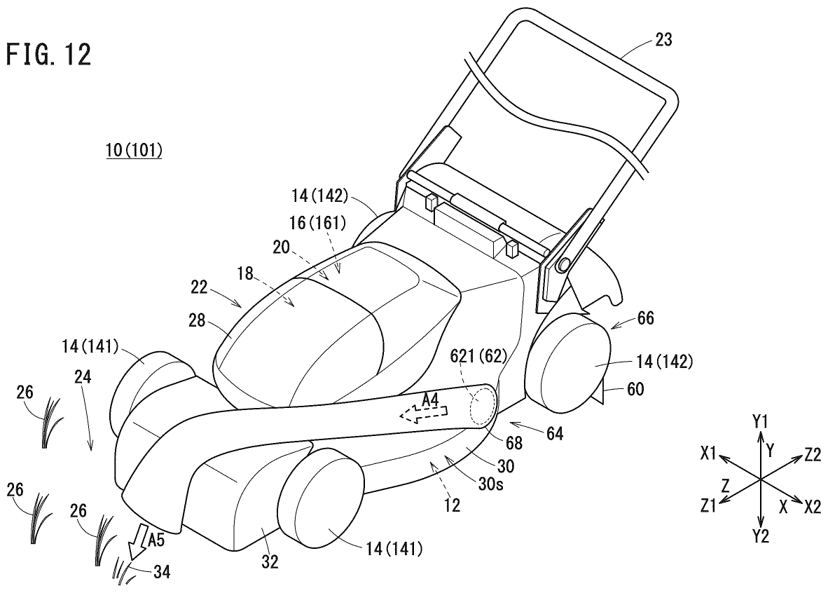

FIG. 12 is a perspective view showing a lawn mower 10 (101) according to an Exemplary Modification 1.

The delivery unit 64 may include a tubular-shaped member 68. The tubular-shaped member 68 extends frontwardly from the blade housing 30. In accordance with this feature, the grass clippings 34a flow inside the tubular-shaped member 68 (arrow A4), and can be delivered frontwardly of the lawn mower 10 (arrow A5). The grass clippings 34a that are delivered frontwardly of the lawn mower 10 can be cut finely by the cutter blade 12. Moreover, it should be noted that the protrusion housing 32 may be omitted.

As shown in FIG. 12, the first opening part 621 (the delivery unit 64) may be formed in the side wall portion 30s of the blade housing 30 (refer also to FIG. 2).

### (Exemplary Modification 2)

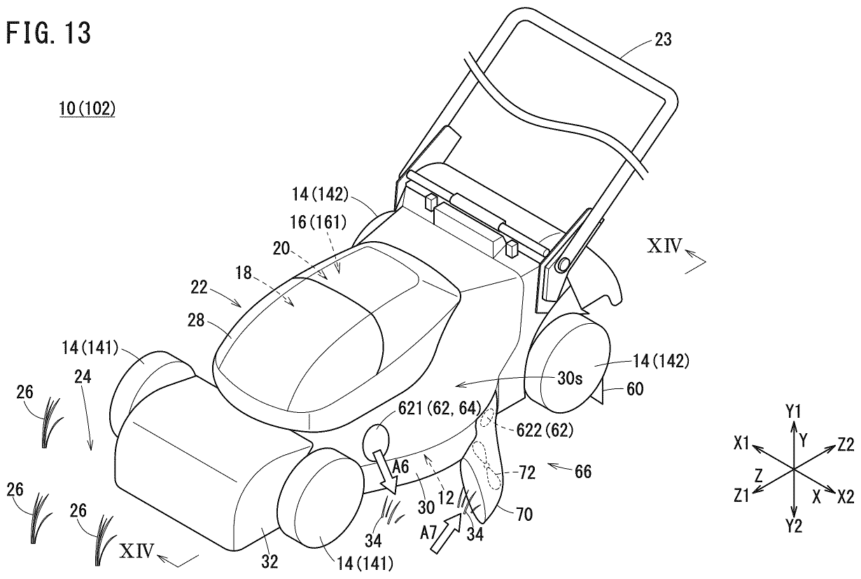

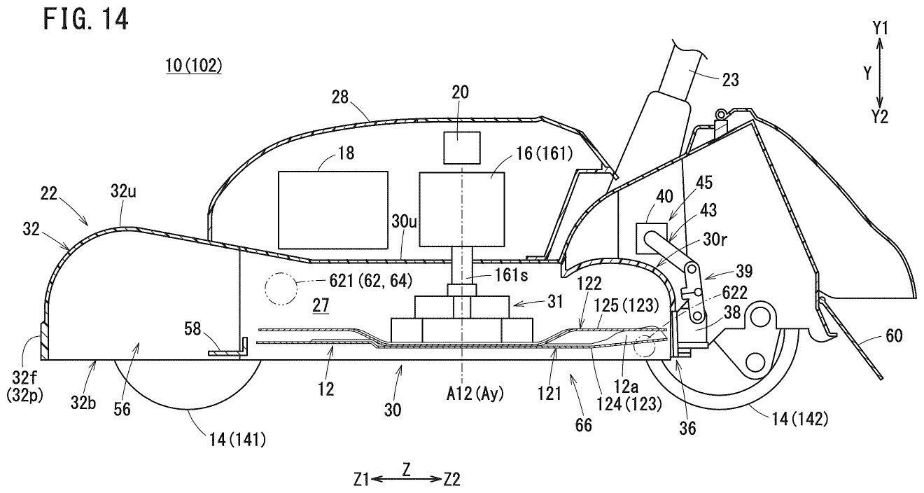

FIG. 13 is a perspective view showing a lawn mower 10 (102) according to an Exemplary Modification 2. FIG. 14 is a cross-sectional view showing the lawn mower 102 according to the Exemplary Modification 2. A cross-sectional view taken along line XIV-XIV of FIG. 13 is shown in FIG. 14.

The first opening part 621 (the delivery unit 64) may be formed in the side wall portion 30s of the blade housing 30. In this case, the opening part 62 (a second opening part 622) for the purpose of carrying the grass clippings 34a into the blade housing 30 may further be formed in the side wall portion 30s. The second opening part 622 can be included in the carry-in unit 66.

The first opening part 621 is positioned frontwardly of the second opening part 622. In accordance with this feature, the grass clippings 34a that have been delivered from the blade housing 30 via the first opening part 621 can be positioned frontwardly of the second opening part 622. Consequently, it becomes easier for the grass clippings 34a to be carried in via the second opening part 622.

As shown in FIG. 14, the first opening part 621 is positioned above the cutter blade 12. Consequently, it becomes easier for the grass clippings 34a to be delivered, via the first opening part 621, to the exterior of the blade housing 30. More specifically, as noted previously, the wing portion 12a provided on the cutter blade 12 is capable of causing an air flow (an upward air flow) A1 flowing in the upward direction Y1 to be generated. In accordance therewith, the air pressure in a region above the cutter blade 12 rises. As a result, it becomes easier for a portion of the air within the blade housing 30 to flow to the exterior of the blade housing 30 via the first opening part 621 that is positioned above the cutter blade 12 (refer also to an arrow A6 in FIG. 13). Therefore, as noted previously, it becomes easier for the grass clippings 34a to be delivered, via the first opening part 621, to the exterior of the blade housing 30.

The second opening part 622 is preferably positioned below the cutter blade 12. Consequently, it becomes easier for the grass clippings 34a to be carried into the blade housing 30 via the second opening part 622. More specifically, in the case that the aforementioned air flow A1 is generated, the air below the cutter blade 12 flows upwardly. As a result, the air pressure in a region below the cutter blade 12 decreases. Stated otherwise, in the case that the cutter blade 12 rotates, the region below the cutter blade 12 becomes a negative pressure region into which air is likely to flow. Accordingly, it becomes easier for the air to flow into the blade housing 30 via the second opening part 622 positioned below the cutter blade 12 (refer also to an arrow A7 in FIG. 13). Therefore, as noted previously, it becomes easier for the grass clippings 34a to be carried, via the second opening part 622, into the blade housing 30.

As shown in FIG. 13, the carry-in unit 66 may include a tubular-shaped member 70. The tubular-shaped member 70 can be provided in the second opening part 622. The tubular-shaped member 70 is capable of guiding the grass clippings 34a to the second opening part 622. The tubular-shaped member 70, for example, extends frontwardly from the second opening part 622, although the present invention is not necessarily limited to this feature.

The carry-in unit 66 may include a suction device 72. The suction device 72 is a device that draws in the grass clippings 34a via the second opening part 622 (refer to the arrow A7). The grass clippings 34a that are drawn in by the suction device 72 are introduced via the second opening part 622 into the blade housing 30. Such a suction device 72 may include, for example, a fan. The suction device 72 is capable of reliably guiding the grass clippings 34a to the second opening part 622.

Moreover, in the same manner as in the Exemplary Modification 1, the protrusion housing 32 may be omitted. Further, in the case that the carry-in unit 66 is equipped with the suction device 72, the position of the second opening part 622 is not necessarily limited to being below the cutter blade 12.

### (Exemplary Modification 3)

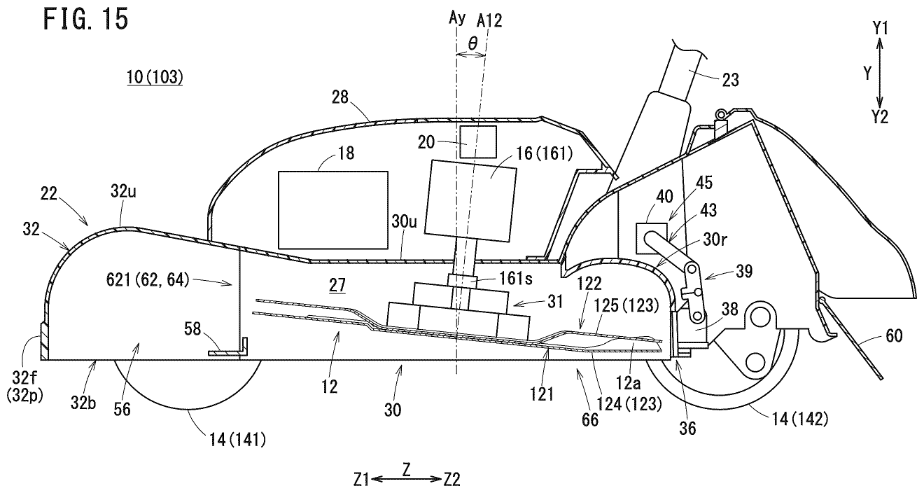

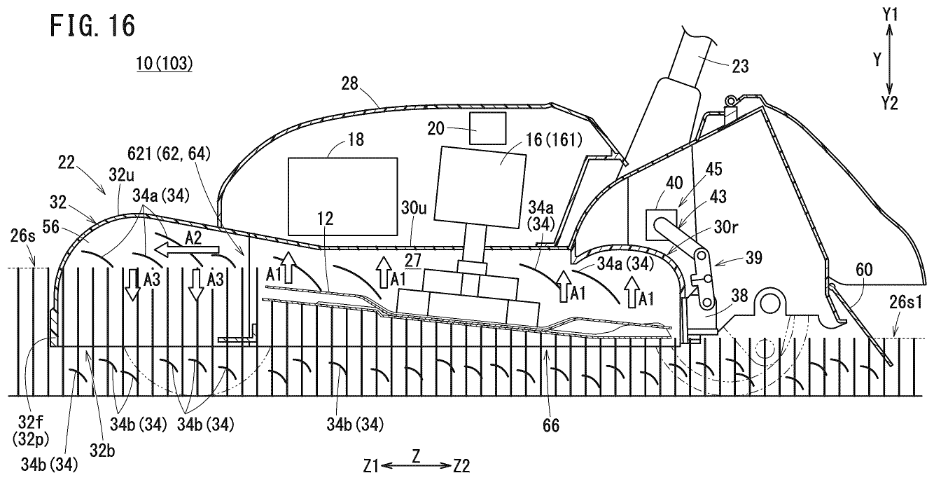

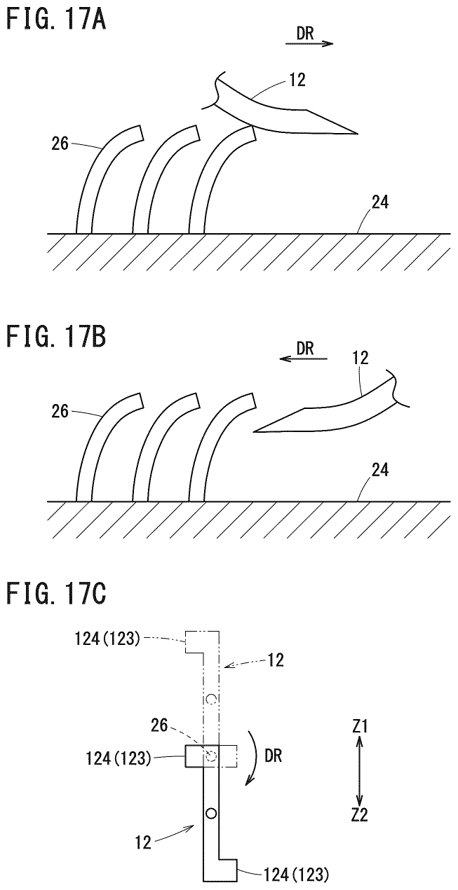

FIG. 15 is a cross-sectional view showing a lawn mower 10 (103) according to an Exemplary Modification 3. FIG. 16 to FIG. 17B are schematic diagrams showing a lawn mowing operation carried out by the lawn mower 103 according to the Exemplary Modification 3.

In the lawn mower 10, the shaft 161s is retained in a manner so that the axis of rotation A12 is inclined rearwardly with respect to an axis Ay in the upward/downward direction. An angle of inclination θ of the axis of rotation A12 with respect to the axis Ay is preferably set to be, for example, greater than or equal to 0.5° and less than or equal to 10°. It is more preferable for the angle of inclination θ to be set to be greater than or equal to 0.5° and less than or equal to 5°. It is further preferable for the angle of inclination θ to be set to be on the order of 1°. The angle of inclination θ does not change during mowing. Moreover, in FIG. 15 and FIG. 16, for the sake of convenience, the rearward inclination of the axis of rotation A12 with respect to the axis Ay is illustrated in an exaggerated manner.

In a state in which the lawn mower 103 is placed on a horizontal surface, the cutter blade 12 becomes lower toward the rear. More specifically, the position of the front end part of the cutter blade 12 in the Y direction is higher than the position of the rear end part of the cutter blade 12 in the Y direction. In accordance with this feature, the cutting height position of the cutter blade 12 located more rearwardly than the axis of rotation A12 is lower than the cutting height position of the cutter blade 12 located frontwardly of the axis of rotation A12. More specifically, as shown in FIG. 16, the grass 26 that is cut by the cutter blade 12 frontwardly of the axis of rotation A12 can be cut even shorter by the cutter blade 12 rearwardly of the axis of rotation A12. Stated otherwise, the cutter blade 12 is capable of cutting the grass 26 at different heights frontwardly and rearwardly of the axis of rotation A12.

A description will now be given concerning the operation of the lawn mower 103.

When the cutter blade 12 rotates while the lawn mower 103 is traveling, the grass 26 growing on the ground directly beneath the lawn mower 103 is cut by the cutter blade 12. Specifically, as shown by the solid line in FIG. 16 and FIG. 17C, the grass 26 is cut by the cutter blade 12 frontwardly of the axis of rotation A12. At this time, the grass 26 that is cut by the cutter blade 12 frontwardly of the axis of rotation A12 in the traveling direction falls (inclines) along the direction of rotation DR as shown in FIG. 17A.

Thereafter, by the lawn mower 103 moving forward, the grass 26 that was cut by the cutter blade 12 is positioned rearwardly of the axis of rotation A12 as shown by the two-dot dashed lines in FIG. 16 and FIG. 17C. At this time, more rearwardly than the axis of rotation A12 in the traveling direction, as shown in FIG. 17B, the cutter blade 12 abuts against the grass 26 from a direction opposite to the direction in which the grass 26 fell. Therefore, the grass 26 is cut again by the cutter blade 12 at a lower position rearwardly of the axis of rotation A12.

Therefore, in the Exemplary Modification 3, more rearwardly than the axis of rotation A12 in the traveling direction, the cutter blade 12 can efficiently cut the grass 26 that has fallen while causing the grass to rise upward.

Moreover, during the rotation of the cutter blade 12, the cutter blade 12 causes an air flow A1, which is an upward air flow, to be generated by the wing portion 12a. Therefore, the grass 26 that is growing on the ground can be made to stand up by the air flow A1, and can be cut efficiently by the cutter blade 12.

Further, the grass 26 (the grass clippings 34a) that are cut by the cutter blade 12 undergo convection inside the housing 22 due to the air flow A1. The grass clippings 34a that are subjected to convection are shredded by the cutter blade 12. The shredded grass clippings 34a fall onto the ground and become the grass clippings 34b, which serve as a fertilizer for the lawn. In this case, since the shredded grass clippings 34b are less likely to accumulate on the grass 26, the appearance of the grass 26 after having been cut is improved.

### (Exemplary Modification 4)

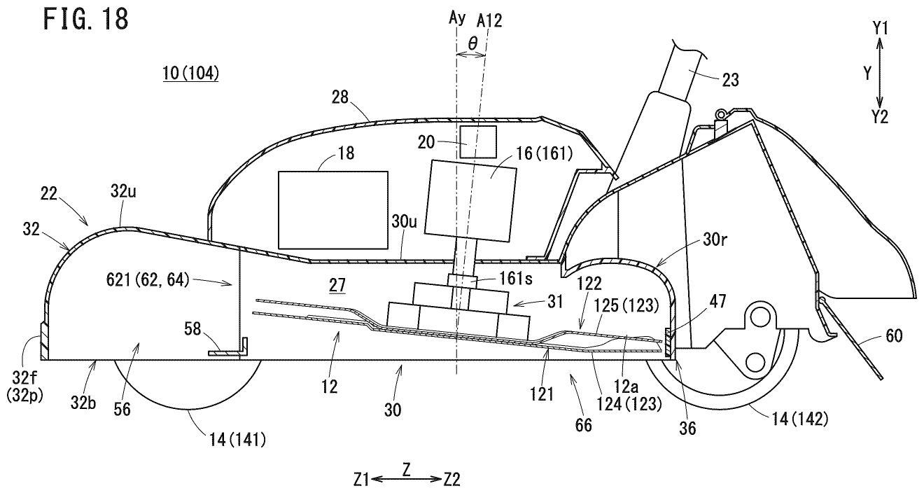

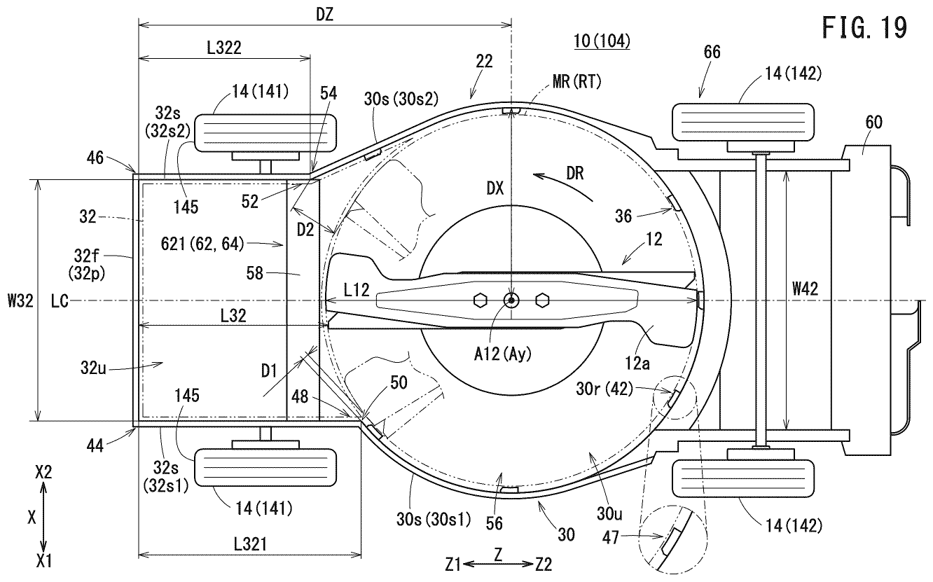

FIG. 18 is a cross-sectional view showing a lawn mower 10 (104) according to an Exemplary Modification 4. FIG. 19 is a bottom view of the lawn mower 104 according to the Exemplary Modification 4.

In the Exemplary Modification 4, the discharge port 42 (refer to FIG. 2 and FIG. 6) is not formed at the rear part 30r of the blade housing 30. Accordingly, the lawn mower 104 does not include the discharge unit 36. The lawn mower 104 as well is capable of performing the operations of the lawn mowers 10, 101, 102, and 103 except for the operation performed by the discharge unit 36.

### Second Embodiment

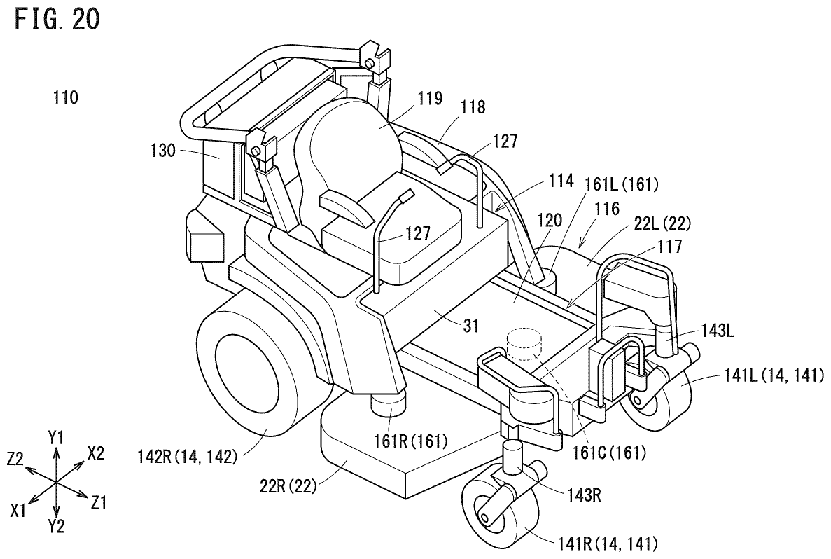

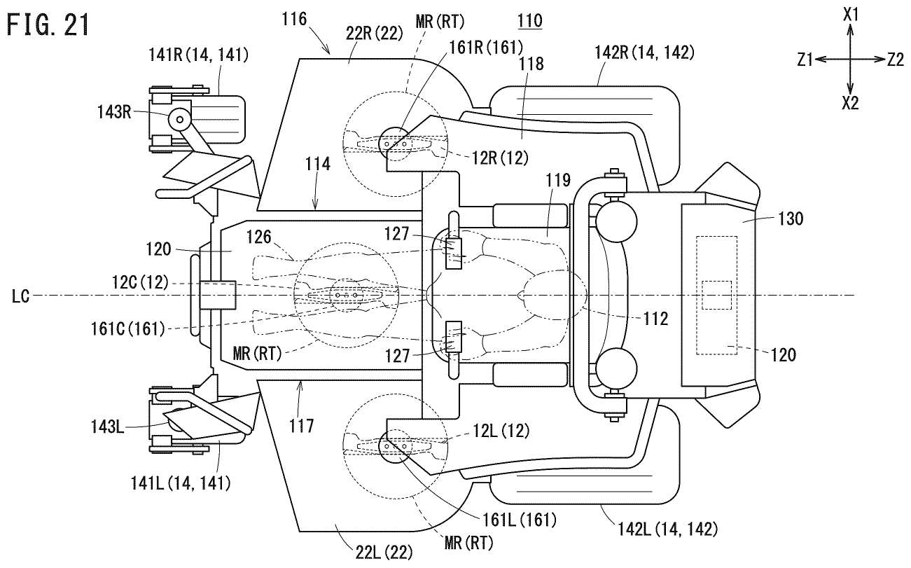

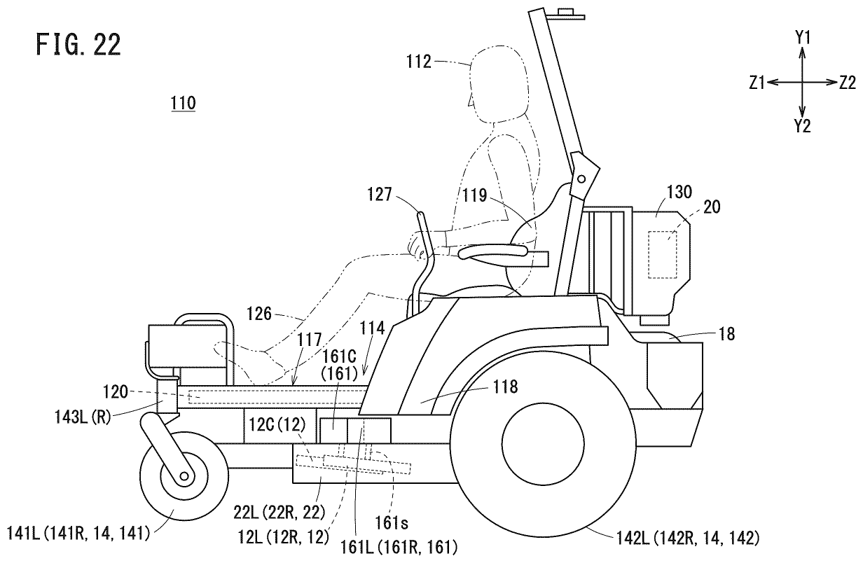

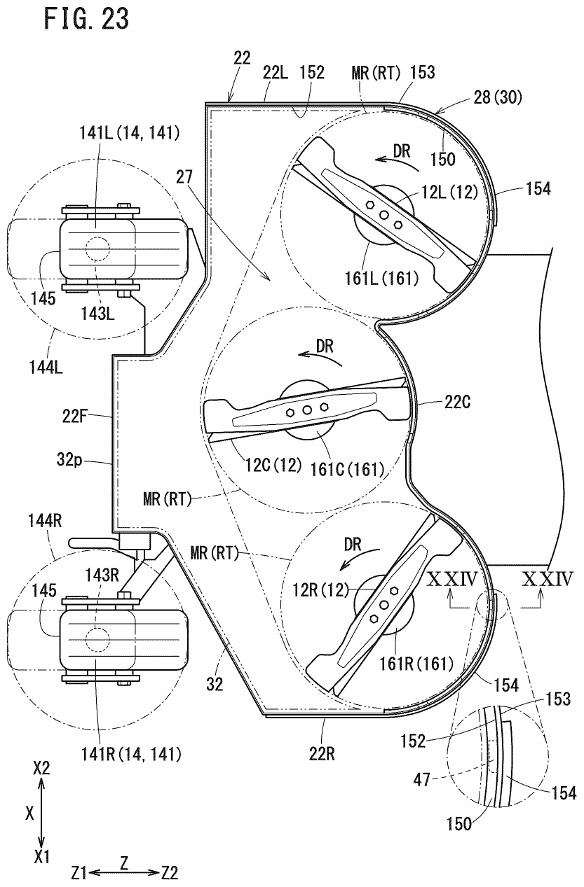

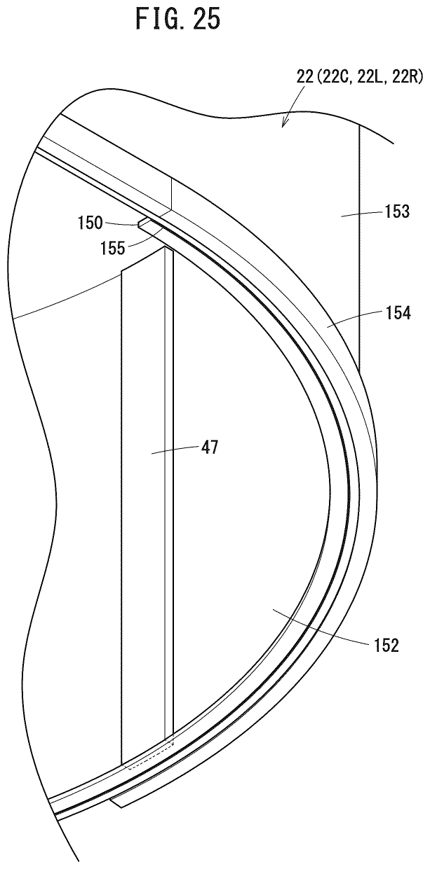

Next, with reference to FIG. 20 to FIG. 28, a description will be given concerning a lawn mower 110 according to a second embodiment. FIG. 20 is a perspective view showing the lawn mower 110 according to the second embodiment. FIG. 21 is a plan view of the lawn mower 110. FIG. 22 is a side view of the lawn mower 110. FIG. 23 is a bottom view of the housing 22 of the lawn mower 110.

The lawn mower 110 is a working machine that is capable of performing at least one of autonomous traveling or autonomous operation. The lawn mower 110 is a working machine on which a crew member 112 (a passenger) is capable of riding. More specifically, the lawn mower 110 is a riding lawn mower.

The lawn mower 110 includes a machine body 114 and a work deck 116.

The machine body 114 includes a vehicle body frame 117, and a cover 118. The vehicle body frame 117 forms a framework for the entire lawn mower 110. The vehicle body frame 117 extends in the frontward/rearward direction. The cover 118 covers the vehicle body frame 117 from the left and the right.

The wheels 14 include a pair of front wheels 141 (a left front wheel 141L and a right front wheel 141R), and a pair of rear wheels 142 (a left rear wheel 142L and a right rear wheel 142R). The left front wheel 141L and the right front wheel 141R have the same shape and size. The left rear wheel 142L and the right rear wheel 142R have the same shape and size. The left front wheel 141L and the right front wheel 141R are smaller in diameter than the left rear wheel 142L and the right rear wheel 142R. The pair of front wheels 141 are driven wheels. The pair of rear wheels 142 are drive wheels. The left rear wheel 142L is rotatably driven by a non-illustrated left traveling motor. The right rear wheel 142R is rotatably driven by a non-illustrated right traveling motor.

The left front wheel 141L and the right front wheel 141R are disposed on a front side (frontwardly) with respect to the center line LC of the lawn mower 110. The left front wheel 141L, in the lawn mower 110, is disposed on the front side of the center line LC, and further, on the left side of the center line LC. The right front wheel 141R, in the lawn mower 110, is disposed on the front side (frontwardly) of the center line LC, and further, on the right side of the center line LC.

The left front wheel 141L and the right front wheel 141R may be casters. In this case, the left front wheel 141L is rotatable about a rotation shaft portion 143L that extends in the upward/downward direction. The right front wheel 141R is rotatable about a rotation shaft portion 143R that extends in the upward/downward direction. Rotation trajectories 144L, 144R of the left front wheel 141L and the right front wheel 141R are shown in FIG. 23.

Moreover, it should be noted that a distance HL between the left front wheel 141L and the center line LC in the leftward/rightward direction is shorter than a distance HR between the right front wheel 141R and the center line LC in the leftward/rightward direction (HL<HR). More specifically, the left front wheel 141L and the right front wheel 141R are disposed asymmetrically with respect to the center line LC.

The left rear wheel 142L and the right rear wheel 142R are disposed on a rear side (rearwardly) with respect to the center line LC of the lawn mower 110. The left rear wheel 142L, in the lawn mower 110, is disposed on the rear side of the center line LC, and further, on the left side of the center line LC. The right rear wheel 142R, in the lawn mower 110, is disposed on the rear side of the center line LC, and further, on the right side of the center line LC.

The work deck 116 is disposed between the pair of front wheels 141 and the pair of rear wheels 142. The work deck 116 is provided in a lower part of the vehicle body frame 117. The work deck 116 includes the housing 22, a plurality of the cutter blades 12, and a plurality of the working motors 161.

The housing 22 is attached to the lower part of the vehicle body frame 117, between the pair of front wheels 141 and the pair of rear wheels 142. As shown in FIG. 1, FIG. 2, and FIG. 4, the housing 22 extends in the leftward/rightward direction from a front part of the vehicle body frame 117. More specifically, the housing 22 includes a central portion 22C that is supported by the front part of the vehicle body frame 117. A left side part of the housing 22 is a left extending portion 22L that extends leftward from the central portion 22C. A right side part of the housing 22 is a right extending portion 22R that extends rightward from the central portion 22C. Further, the housing 22 includes a front extending portion 22F that extends frontwardly from the central portion 22C.

According to the second embodiment, a distal end part of the front extending portion 22F corresponds to the protruding end 32p of the protrusion housing 32. The protruding end 32p is disposed more rearwardly than each of the front ends 145 of the pair of front wheels 141.

The plurality of working motors 161 include, for example, a left motor 161L, a right motor 161R, and a central motor 161C. The left motor 161L is attached to the left extending portion 22L. The shaft 161s of the left motor 161L extends downwardly on the inner side of the left extending portion 22L. The right motor 161R is attached to the right extending portion 22R. The shaft 161s of the right motor 161R extends downwardly on the inner side of the right extending portion 22R. The central motor 161C is attached to the central portion 22C. The shaft 161s of the central motor 161C extends downwardly on the inner side of the central portion 22C.

The plurality of cutter blades 12 include a left cutter blade 12L, a right cutter blade 12R, and a central cutter blade 12C. The left cutter blade 12L is rotatably supported on the shaft 161s of the left motor 161L on the inner side of the left extending portion 22L. The right cutter blade 12R is rotatably supported on the shaft 161s of the right motor 161R on the inner side of the right extending portion 22R. The central cutter blade 12C is rotatably supported on the shaft 161s of the central motor 161C on the inner side of the central portion 22C. Accordingly, the plurality of cutter blades 12 have mutually different axes of rotation A12 from each other. The plurality of cutter blades 12 are covered from above by the housing 22. Further, the plurality of cutter blades 12 are disposed adjacent to each other in the leftward/rightward direction. Further, as shown in FIG. 21 and FIG. 23, the cutter blades 12 are disposed diagonally adjacent to each other.

Each of the plurality of cutter blades 12 rotates about the axis of its shaft 161s as the working motor 161 is driven. In FIG. 21 and FIG. 23, the rotation trajectories RT of the cutter blades 12 are shown. Corresponding to the plurality of rotation trajectories RT, the side parts and the rear part of the housing 22 (the right extending portion 22R, the left extending portion 22L, and the rear part of the central portion 22C) are formed in an arcuate shape.

According to the second embodiment, the central portion 22C, the left extending portion 22L, and the right extending portion 22R of the housing 22 serve in a dual manner as the motor housing 28 and the blade housing 30. Further, the portion of the housing 22 that is located frontwardly of the mowing range MR and the rotation trajectory RT serves as the protrusion housing 32. In FIG. 23, a portion of the protrusion housing 32 is illustrated by a one-dot dashed line. Accordingly, on the inner side of the housing 22, the portion thereof more rearward than the region indicated by the one-dot dashed line forms the internal space 27. Stated otherwise, the protrusion housing 32 is disposed in a manner so as to communicate with the internal space 27 (the motor housing 28 and the blade housing 30) and so as to straddle over a plurality of the mowing ranges MR and the rotation trajectories RT in the leftward/rightward direction.

A flange 150 (a flange member) is provided on the inner side of the housing 22. Specifically, the flange 150 is disposed on a portion of an inner wall 152 of the housing 22 that is located below the plurality of cutter blades 12 in the Y direction. The flange 150 is disposed on a lower end of the inner wall 152 of the housing 22. The flange 150 is disposed at the lower end of the inner wall 152 in a manner so as to straddle over the side part and the rear part of the left extending portion 22L, the rear part of the central portion 22C, and the side part and the rear part of the right extending portion 22R. The flange 150 projects out inwardly toward the internal space 27. Accordingly, from within the inner wall 152, the flange 150 is not disposed on a portion of the protrusion housing 32. Moreover, the inner wall 152 is a wall portion on the inner side of the housing 22. The inner wall 152 can also be considered as a surface that faces toward the inner side of the housing 22.

In the second embodiment, the constituent material of the housing 22 is a metal. The flange 150 is provided on a lower end part of the inner wall 152, by welding a curved member, which matches the shape of the inner wall 152 of the housing 22, to the lower end part of the inner wall 152. Accordingly, a bead 155 is formed below a joined portion between the inner wall 152 and the flange 150.

Two reinforcing ribs 154 (reinforcing members) are disposed on an outer wall 153 of the housing 22. The two reinforcing ribs 154 project out from the outer wall 153 of the housing 22. The two reinforcing ribs 154 are provided on a lower side portion of the outer wall 153 of the housing 22. The two reinforcing ribs 154 are formed on the lower side portion of the outer wall 153, one on the side part and the rear part of the left extending portion 22L, and the other on the side part and the rear part of the right extending portion 22R. The one of the reinforcing ribs 154 is disposed from the side part to a center position of the rear part of the left extending portion 22L. The other of the reinforcing ribs 154 is disposed from the side part to a center position of the rear part of the right extending portion 22R. Lower ends of the two reinforcing ribs 154 project out more downwardly than the lower end of the housing 22 and the flange 150. Moreover, the outer wall 153 is a wall portion on the outer side of the housing 22. The outer wall 153 can also be considered as a surface that faces toward the outer side of the housing 22.

The reinforcing ribs 154 are provided on the lower side portion of the outer wall 153, by welding a curved member, which matches the shape of the outer wall 153 of the housing 22, to the lower side portion of the outer wall 153. Accordingly, a bead 156 is formed at a joined portion between the outer wall 153 and the reinforcing ribs 154.

In this instance, a thickness (a plate thickness) of the housing 22 (the central portion 22C, the left extending portion 22L, and the right extending portion 22R) is defined as L22. A protruding length of the flange 150 from the inner wall 152 of the housing 22 is defined as L150. A length from the outer wall 153 of the housing 22 to the protruding end of the flange 150 is defined as L151. The length L151 is a sum of the thickness L22 of the housing 22 and the protruding length L150 of the flange 150 (L151=L22+L150). When viewed from the Y direction, a distance between the distal end of the cutter blade 12 and the protruding end of the flange 150 at is defined as L121. A distance between the inner wall 152 of the housing 22 and the distal end of the cutter blade 12 is defined as L123. The distance L123 is a sum of the distance L121 and the protruding length L150 (L123=L121+L150). A distance between the lower end of the cutter blade 12 and the upper end of the flange 150 is defined as L122.

In this case, it is desirable for the distance L123 to be greater than the distance L122 (L123>L122). Furthermore, the thickness L22 and the protruding length L150 may be of the same size (L22=L150). The protruding length L150 may be greater than the distance L121 (L150>L121).

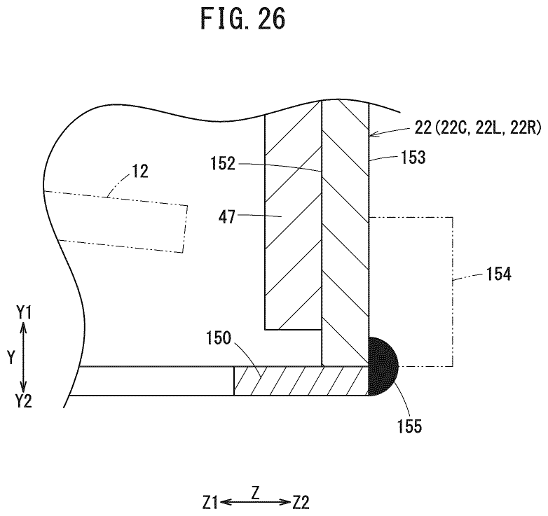

FIG. 26 shows a Comparative Example 1. In the Comparative Example 1, the flange 150 is joined by welding to the lower end of the housing 22. In accordance therewith, the bead 155 is formed on the outer side of the flange 150 and the housing 22. Therefore, in the Comparative Example 1, in the case that the reinforcing ribs 154 were provided on the housing 22, due to the presence of the bead 155, it would be impossible to provide the reinforcing ribs 154 on the housing 22.

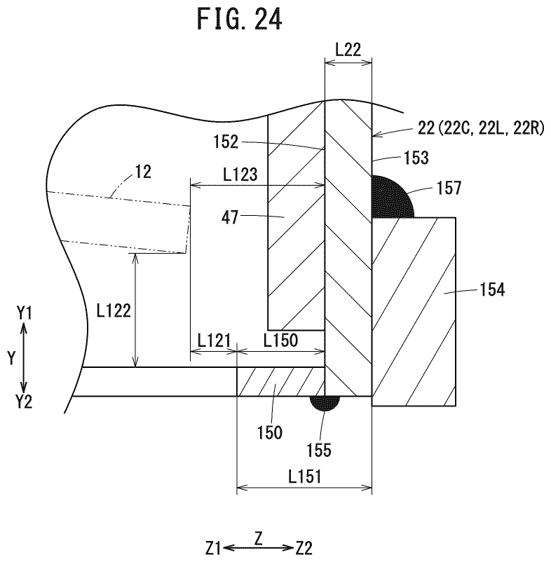

In contrast thereto, according to the second embodiment, as shown in FIG. 24, since the bead 155 is formed below the joined portion between the inner wall 152 and the flange 150, the reinforcing ribs 154 can be easily provided on the outer wall 153 of the housing 22.

Further, in the second embodiment, by providing the reinforcing ribs 154, the mechanical strength of the flange 150 and the connecting portion between the flange 150 and the inner wall 152 of the housing 22 (the joined portion including the bead 155) can be effectively reinforced. Furthermore, by providing the reinforcing ribs 154, it is possible to adequately protect, from obstacles such as stones or the like from the exterior of the lawn mower 110, the flange 150 and the connecting portion between the flange 150 and the inner wall 152 of the housing 22. In addition, since the lower ends of the reinforcing ribs 154 project out more downwardly than the lower end of the housing 22 and the flange 150, the flange 150 and the connecting portion between the flange 150 and the inner wall 152 of the housing 22 can be effectively protected.

The protruding parts 47 are provided on the inner wall 152 of the housing 22 at regular intervals along the circumferential direction of the inner wall 152. The protruding parts 47, on the inner wall 152, are provided above the flange 150. Accordingly, the protruding parts 47 and the flange 150 are provided on the inner wall 152 with a gap therebetween in the upward/downward direction. Moreover, the protruding parts 47 are attached to the inner wall 152 by welding, an adhesive, or the like.

The plurality of working motors 161 may be two motors (the left motor 161L, and the right motor 161R). The plurality of cutter blades 12 may be two blades (the left cutter blade 12L, and the right cutter blade 12R).

A footrest portion 120, a seat 119, and a pair of control levers 127 are provided on the vehicle body frame 117.

The footrest portion 120 is disposed on the front part of the vehicle body frame 117. The seat 119 is disposed rearwardly of the footrest portion 120, at an intermediate part and a rear part of the vehicle body frame 117. The seat 119 is located at a higher position than the footrest portion 120.

The crew member 112, by placing his or her feet 126 on the footrest portion 120 of the lawn mower 110, boards or rides on the lawn mower 110. The crew member 112 sits on the seat 119 in a state in which his or her feet 126 are placed on the footrest portion 120. Further, the crew member 112, by standing up from the seat 119 and placing his or her feet 126 on the ground, dismounts from the lawn mower 110.

The pair of control levers 127 are disposed diagonally in front of the seat 119. The crew member 112 is capable of operating the control levers 127 in a state of being seated on the seat 119.

A control box 130 is disposed rearwardly of the seat 119. The control box 130 is a housing in which the control unit 20 is accommodated. The control box 130 is supported at the rear part of the vehicle body frame 117. In the upward/downward direction, the battery 18 is disposed below the seat 119 and the control box 130. The control unit 20, at a time when electrical power is being supplied thereto from the battery 18, controls each of the respective parts of the lawn mower 110 such as the working motors 161 and the like, based on the operation of the control levers 127 by the crew member 112 who is seated on the seat 119.

A description will now be given concerning the operation of the lawn mower 110. In this instance, a description will be given concerning a case in which the lawn mower 110 travels with a human operator, and a case in which the lawn mower 110 travels in an unmanned manner.

At first, a case will be described in which the lawn mower 110 travels with a human operator.

The crew member 112 places his or her feet 126 on the footrest portion 120. In accordance therewith, the crew member 112 boards or rides on the lawn mower 110. The crew member 112 sits on the seat 119 in a state in which his or her feet 126 are placed on the footrest portion 120.

Next, the crew member 112, by operating a non-illustrated ON switch, causes the lawn mower 110 to be started. The control unit 20, based on the operation of the ON switch by the crew member 112, initiates the supply of electrical power from the battery 18 to each of the respective parts of the lawn mower 110.

Accompanying the control levers 127 being operated by the crew member 112, the lawn mower 110 moves frontward, moves rearward, stops, or turns. More specifically, the control unit 20, by controlling the driving of the traveling motors in response to the operation of the control levers 127 by the crew member 112, causes the lawn mower 110 to move frontward, to move rearward, to stop, or to turn. In addition, the term turning includes pivot turning, as well as spin turning.

The control unit 20, by controlling the driving of the working motor 161 provided on the work deck 116 in response to the operation of the control levers 127 by the crew member 112, causes the cutter blade 12 to be rotated or stopped. Accordingly, the lawn mower 110 carries out the lawn mowing operation in the working region.

When the lawn mowing operation in the working region is completed, the crew member 112 causes the traveling of the lawn mower 110 to be stopped, and thereafter, operates a non-illustrated OFF switch. The control unit 20, based on the operation of the OFF switch by the crew member 112, causes the supply of the electrical power from the battery 18 to each of the respective parts of the lawn mower 110 to be stopped. As a result, the operation of the lawn mower 110 is stopped.

Next, by standing up from the seat 119 and moving from the footrest portion 120 to the ground, the crew member 112 dismounts from the lawn mower 110.

Next, a case will be described in which the lawn mower 110 travels in an unmanned manner. During unmanned traveling, a teaching process and a playback process are carried out. In the teaching process, by performing the above-described traveling with the human operator, the travel route of the lawn mower 110 in the working region that serves as a target of the lawn mowing operation is stored in the lawn mower 110. In the playback process, in an unmanned state in which the crew member 112 is not riding on the lawn mower 110, the lawn mower 110 performs the lawn mowing operation while traveling along the travel route that is stored in the teaching process. Stated otherwise, in the playback process, the lawn mower 110 performs autonomous traveling and autonomous operation.

At first, in the teaching process, the aforementioned traveling with the human operator is carried out in a state in which the operator is riding on the lawn mower 110 in the working region that serves as the target of the lawn mowing operation. At this time, the control unit 20 stores the path (the travel route) that is traveled by the lawn mower 110 in a non-illustrated storage device.

Next, in the playback process, in accordance with the travel route that is stored in the storage device, the control unit 20 controls the driving of the left traveling motor and the right traveling motor, and thereby causes the lawn mower 110 to travel autonomously in the working region. Further, the control unit 20, by controlling the driving of the working motor 161, causes the cutter blade 12 to be rotated, and the lawn mowing operation to be carried out in an autonomous manner.

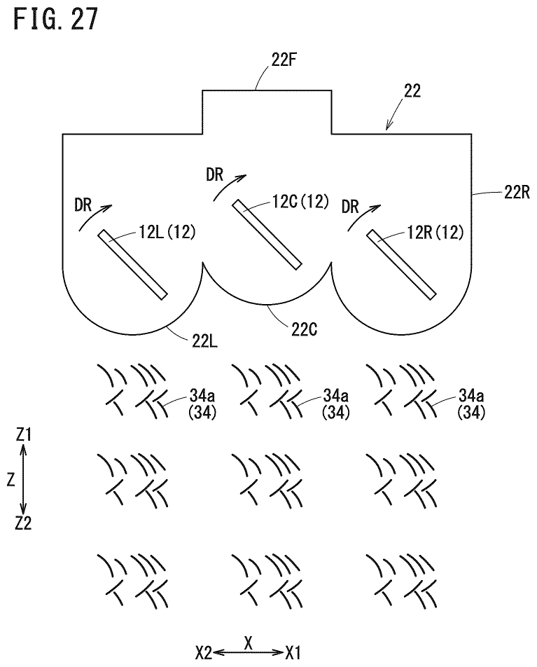

FIG. 27 is a diagram showing the lawn mowing operation according to a Comparative Example 2. In the Comparative Example 2, the flange 150 is not provided. Therefore, in the Comparative Example 2, the grass clippings 34a are discharged rearwardly of the housing 22. In accordance with this feature, together with the quality of the lawn mowing declining, the cutting of the grass clippings 34a also declines.

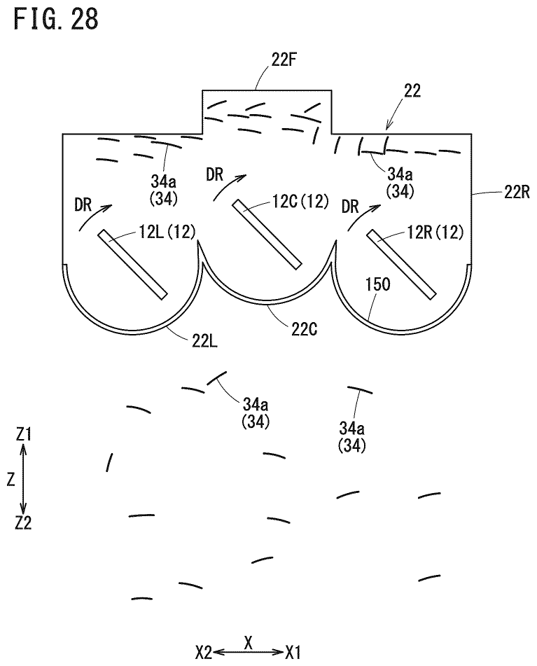

In contrast thereto, according to the second embodiment, as shown in FIG. 28, the flange 150 is provided on the housing 22. Therefore, the amount of the grass clippings 34a that are discharged rearwardly of the housing 22 is reduced. In accordance with this feature, together with the quality of the lawn mowing being improved, the cutting of the grass clippings 34a is also improved.

### Other Embodiments

In the above-described embodiments, the lawn mowers 10 and 101 to 104 (refer to FIG. 1 to FIG. 19) may have the configuration of the lawn mower 110 according to the second embodiment. For example, the flange 150 may be provided on the inner wall 33 of the peripheral wall 30p of each of the lawn mowers 10 and 101 to 104. Further, the reinforcing ribs 154 may be provided on the outer wall of the peripheral wall 30p.

The following Supplementary Notes are further disclosed in relation to the above-described embodiments.

### (Supplementary Note 1)

The lawn mower (10, 101 to 104, 110) according to the first aspect of the present disclosure comprises the cutter blade (12, 12C, 12L, 12R) that cuts the grass (26), the drive source (16) that drives the cutter blade, and the housing (22) including the blade accommodating portion (MR) in which the cutter blade is accommodated, and the protruding part (32) that projects out from the blade accommodating portion in a frontward direction (Z1) in a frontward/rearward direction (Z) with respect to a traveling direction, and that communicates with the blade accommodating portion. In accordance with such features, the lawn mower that is capable of cutting the grass more efficiently is provided. More specifically, the grass clippings that are cut by the cutter blade are blown frontwardly. As the lawn mower moves frontward, the grass clippings that have been blown outside are cut again. In this manner, by cutting the grass twice, the quality of the work, such as the appearance or the like of the lawn after the lawn mowing operation, can be improved.

### (Supplementary Note 2)

In the lawn mower according to Supplementary Note 1, the lawn mower may be a rotary lawn mower in which the cutter blade is disposed rotatably about the axis of rotation (A12), the housing may include the partition member (30) that partitions the blade accommodation space including the blade accommodating portion from the exterior of the lawn mower, the partition member may include the inner wall (33) surrounding the outer side of the cutter blade in the circumferential direction with respect to the axis of rotation, and the distance (DZ) between the axis of rotation and the front end (32p) of the protruding part in the frontward/rearward direction may be greater than the distance (DX) between the axis of rotation and the inner wall in the leftward/rightward direction (X) orthogonal to the frontward/rearward direction. In accordance with such features, the grass clippings become capable of easily flowing into the protruding part.

### (Supplementary Note 3)

In the lawn mower according to Supplementary Note 1 or Supplementary Note 2, the lower part (32b) of the protruding part in the upward/downward direction Y orthogonal to the frontward/rearward direction may be open. In accordance with this feature, the grass clippings that are sufficiently finely shredded enter beneath the grass surface, and the grass clippings that are not sufficiently finely shredded will naturally fall frontwardly of the cutter blade.

### (Supplementary Note 4)

In the lawn mower according to any one of Supplementary Note 1 to Supplementary Note 3, the maximum dimension (W32) of the protruding part in the leftward/rightward direction orthogonal to the frontward/rearward direction may be less than the longitudinal dimension (L12) of the cutter blade. In accordance with this feature, the grass clippings that flow into the protruding part more reliably fall frontwardly of the cutter blade.

(Supplementary Note 5) In the lawn mower according to any one of Supplementary Note 1 to Supplementary Note 4, the protruding part may include the first side wall portion (32s1) which is positioned on one side of the center line (LC) and extends along the frontward/rearward direction, the center line passing through the center of the lawn mower in the leftward/rightward direction orthogonal to the frontward/rearward direction and extending in the frontward/rearward direction, and the second side wall portion (32s2) which is positioned on the other side of the center line and extends along the frontward/rearward direction. In accordance with such features, a larger amount of the grass clippings can be made to fall frontwardly of the cutter blade.

### (Supplementary Note 6)

In the lawn mower according to Supplementary Note 5, the lawn mower may be a rotary lawn mower in which the cutter blade is disposed rotatably about the axis of rotation, and the first side wall portion may be the side wall portion that is positioned further forward than the second side wall portion in the direction of rotation (DR) of the cutter blade. In accordance with this feature, a larger amount of the grass clippings can be received by the first side wall portion. By causing the grass clippings to collide with the first side wall portion, the grass clippings can be more reliably made to fall.

### (Supplementary Note 7)

In the lawn mower according to Supplementary Note 5 or Supplementary Note 6, the dimension (L321) of the first side wall portion in the frontward/rearward direction may be greater than the dimension (L322) of the second side wall portion in the frontward/rearward direction. In accordance with this feature, a larger amount of the grass clippings can be received efficiently by the first side wall portion. Further, the second side wall portion 32s2 is less likely to hinder the flow of the grass clippings toward the first side wall portion.

### (Supplementary Note 8)

In the lawn mower according to any one of Supplementary Note 5 to Supplementary Note 7, the lawn mower may be a rotary lawn mower in which the cutter blade is disposed rotatably about the axis of rotation, and in one rotation of the cutter blade, a part of the first side wall portion may overlap with a part of the cutter blade when viewed from the leftward/rightward direction, in a state in which the longitudinal direction of the cutter blade coincides with the frontward/rearward direction. In accordance with this feature, a larger amount of the grass clippings can be made to fall frontwardly of the cutter blade by

### (Supplementary Note 9)

In the lawn mower according to any one of Supplementary Note 5 to Supplementary Note 8, the lawn mower may be a rotary lawn mower in which the cutter blade is disposed rotatably about the axis of rotation, and in one rotation of the cutter blade, the distance (D2) between the cutter blade and the rear end (52) of the second side wall portion in the frontward/rearward direction in a state in which the cutter blade and the rear end of the second side wall portion are closest in proximity to each other may be greater than the distance (D1) between the cutter blade and the rear end (48) of the first side wall portion in the frontward/rearward direction in a state in which the cutter blade and the rear end of the first side wall portion are closest in proximity to each other. In accordance with such features, while a larger amount of the grass clippings are guided toward the first side wall portion by the second side wall portion, a larger amount of the grass clippings can be made to fall frontwardly of the cutter blade by the first side wall portion.

(Supplementary Note 10) In the lawn mower according to any one of Supplementary Note 5 to Supplementary Note 9, the lawn mower may further comprise the rib (58) that connects the first side wall portion and the second side wall portion. In accordance with this feature, a situation in which the protruding part bends is suppressed.

### (Supplementary Note 11)

In the lawn mower according to any one of Supplementary Note 1 to Supplementary Note 10, the maximum dimension (L32) of the protruding part in the frontward/rearward direction may be greater than or equal to one third of the longitudinal dimension of the cutter blade. In accordance with this feature, a larger amount of the grass clippings may be made to flow into the protruding part.

### (Supplementary Note 12)

In the lawn mower according to any one of Supplementary Note 1 to Supplementary Note 11, the lawn mower may further comprise the grass dropping tool (60) that is disposed rearwardly of the housing in the frontward/rearward direction, and drops the grass clippings (34) which are pieces of the grass that has been cut and adhere to the grass surface (26s1), from the grass surface. In accordance with this feature, the grass surface rearwardly of the lawn mower can be put in order.

### (Supplementary Note 13)

In the lawn mower according to Supplementary Note 12, the grass dropping tool may include the plate-shaped member or the brush member. In accordance with this feature, the grass surface rearwardly of the lawn mower can be effectively put in order.

### (Supplementary Note 14)

In the lawn mower according to Supplementary Note 12 or Supplementary Note 13, the lower end of the grass dropping tool may be located lower than the lower end of the cutter blade in the upward/downward direction orthogonal to the frontward/rearward direction. In accordance with this feature, the grass surface rearwardly of the lawn mower can be more effectively put in order.

### (Supplementary Note 15)

In the lawn mower according to any one of Supplementary Note 1 to Supplementary Note 14, the housing may include the partition member that partitions the blade accommodation space including the blade accommodating portion from the exterior of the lawn mower, and the lawn mower may further comprise the discharge unit (36) that is disposed at the rear part (30r) of the partition member in the frontward/rearward direction, and discharges the grass clippings that have been cut by the cutter blade from the blade accommodation space to the exterior of the lawn mower. In accordance with such features, since the grass clippings inside the blade accommodating portion are discharged from the discharge unit, the load on the cutter blade can be reduced.

### (Supplementary Note 16)

In the lawn mower according to Supplementary Note 15, the discharge unit may include the opening part (42) that allows communication between the inner side and the outer side of the partition member, and the cover member (38) that is provided to be capable of opening and closing the opening part. In accordance with such features, in the case that the load on the cutter blade becomes large, by opening the opening part by opening the cover member, the grass clippings can be discharged rearwardly of the lawn mower from the blade accommodating portion. As a result, together with the load on the cutter blade being reduced, it is possible to suppress the electrical power consumption of the lawn mower.

### (Supplementary Note 17)

In the lawn mower according to any one of Supplementary Note 1 to Supplementary Note 16, the lawn mower may be a rotary lawn mower in which the cutter blade is disposed rotatably about the axis of rotation, and the cutter blade may include the wing portion (12a) that is inclined upwardly toward a reverse direction of rotation that is an opposite direction to the direction of rotation of the cutter blade. In accordance with this feature, the upwardly directed air flow can be generated in response to the rotation of the cutter blade.

### (Supplementary Note 18)

In the lawn mower according to any one of Supplementary Note 1 to Supplementary Note 17, the lawn mower may be a rotary lawn mower in which the cutter blade is disposed rotatably about the axis of rotation, the housing may include the partition member that partitions the blade accommodation space including the blade accommodating portion from the exterior of the lawn mower, the partition member may include the inner wall surrounding the outer side of the cutter blade in the circumferential direction with respect to the axis of rotation, the cutter blade may include the cutting portion (123) provided at least at a portion facing toward the inner wall, and another protruding part (47) that projects out from the inner wall toward the axis of rotation may be provided on the inner wall. In accordance with such features, it is possible to provide the lawn mower that is capable of suitably mowing the grass.

### (Supplementary Note 19)

In the lawn mower according to Supplementary Note 18, the protruding part may include the plurality of protruding parts (47) disposed to be spaced apart from each other in the direction of rotation of the cutter blade, and the pitch (P47) between the protruding parts that are adjacent to each other in the direction of rotation may be greater than the dimension (L13) of the cutter blade in the direction of rotation. In accordance with this feature, any risk of the grass clippings becoming sandwiched and retained between the protruding parts that are adjacent to each other can be reduced.

### (Supplementary Note 20)

In the lawn mower according to Supplementary Note 18 or Supplementary Note 19, the lawn mower may further comprise the discharge unit that is disposed at the rear part of the partition member in the frontward/rearward direction, and discharges the grass clippings that have been cut by the cutter blade from the blade accommodation space to the exterior of the lawn mower, wherein the discharge unit may include the opening part that allows communication between the inner side and the outer side of the inner wall of the partition member, and the cover member that is provided to be capable of opening and closing the opening part, the cover member may be provided in a manner so as to form the inner wall in a state of closing the opening part, and the other protruding part may be provided so as to project out from the cover member toward the axis of rotation. In accordance with such features, in the case that the load on the cutter blade becomes large, by opening the opening part by opening the cover member, the grass clippings can be discharged rearwardly of the lawn mower from the blade accommodating portion. As a result, together with the load on the cutter blade being reduced, it is possible to suppress the electrical power consumption of the lawn mower. Further, the other protruding part projects out from the cover member toward the axis of rotation. In accordance with this feature, the other protruding part and the cutter blade can cooperatively and effectively cut the grass.

(Supplementary Note 21) In the lawn mower according to any one of Supplementary Note 1 to Supplementary Note 20, the lawn mower may further comprise the left wheel (14) and the right wheel (14) that are disposed to be spaced apart from each other in the leftward/rightward direction orthogonal to the frontward/rearward direction, wherein the protruding part may overlap with the left wheel and the right wheel when viewed from the leftward/rightward direction. In accordance with this feature, the lawn mower can be constituted in a compact manner.

### (Supplementary Note 22)

In the lawn mower according to Supplementary Note 21, the front end of the protruding part in the frontward/rearward direction may be disposed more frontwardly than each of the front ends (145) of the left wheel and the right wheel in the frontward/rearward direction. In accordance with this feature, a larger volume for the protruding part is ensured, thereby increasing the amount of the grass clippings that are scattered frontwardly. As a result, the grass clippings that have been scattered frontwardly can be cut again.

### (Supplementary Note 23)

In the lawn mower according to Supplementary Note 21, the front end of the protruding part in the frontward/rearward direction may be disposed more rearwardly than each of the front ends of the left wheel and the right wheel in the frontward/rearward direction. In accordance with this feature, at a time when the lawn mower moves forward or turns, any risk of an obstacle colliding with the protruding part and an external force being applied to the protruding part can be reduced.

(Supplementary Note 24) In the lawn mower according to any one of Supplementary Note 21 to Supplementary Note 23, the left wheel and the right wheel may be offset to one side in the leftward/rightward direction with respect to the center line that passes through the center of the lawn mower in the leftward/rightward direction and extends in the frontward/rearward direction. In accordance with this feature, in the case that the lawn mower is a riding lawn mower, it becomes possible for the user to easily board the lawn mower from the other side.

### (Supplementary Note 25)

In the lawn mower according to any one of Supplementary Note 1 to Supplementary Note 24, the cutter blade may include the plurality of cutter blades (12C, 12L, 12R), the plurality of cutter blades may be disposed adjacent to each other in the leftward/rightward direction orthogonal to the frontward/rearward direction, and the protruding part may communicate with the plurality of blade accommodating portions of the plurality of cutter blades. In accordance with such features, the grass clippings that are cut by each of the cutter blades can be made to move efficiently to the frontward protruding part.

### (Supplementary Note 26)

In the lawn mower according to any one of Supplementary Note 1 to Supplementary Note 25, the cutter blade may include the plurality of cutter blades, the plurality of cutter blades may be disposed adjacent to each other in the leftward/rightward direction orthogonal to the frontward/rearward direction, and the protruding part may be disposed frontwardly of the plurality of blade accommodating portions of the plurality of cutter blades in the frontward/rearward direction, and provided in a manner so as to be disposed to straddle over the plurality of blade accommodating portions in the leftward/rightward direction. In accordance with such features, the grass clippings that are cut by each of the cutter blades can be made to move effectively to the frontward protruding part.

### (Supplementary Note 27)

In the lawn mower according to any one of Supplementary Note 1 to Supplementary Note 26, the lawn mower may be a rotary lawn mower in which the cutter blade is disposed rotatably about the axis of rotation, the housing may include the partition member that partitions the blade accommodation space including the blade accommodating portion from the exterior of the lawn mower, the partition member may include the inner wall surrounding the outer side of the cutter blade in the circumferential direction with respect to the axis of rotation, and the flange member (150) that projects out toward the axis of rotation may be provided on the portion of the inner wall that is located below the cutter blade in the vertical direction. In accordance with such features, while avoiding interference with the cutter blade, it is possible to reduce scattering of the grass clippings rearwardly during mowing. As a result, together with the quality of the lawn mowing being improved, the cutting of the grass is also improved.

### (Supplementary Note 28)

In the lawn mower according to Supplementary Note 27, the housing may include the reinforcing member (154) that is fixed to the outer wall (153) of the partition member, and the reinforcing member may be provided in a manner so that the lower end of the reinforcing member is positioned below the lower end of the flange member in the vertical direction. In accordance with such features, it is possible to effectively reinforce the mechanical strength of the flange member and the connecting portion between the flange member and the inner wall of the partition member. Further, by providing the reinforcing member, it is possible to adequately protect the flange member and the connecting portion between the flange member and the inner wall of the partition member from obstacles and the like outside the lawn mower.

### (Supplementary Note 29)

The lawn mower (10) according to the second aspect of the present disclosure may comprise the cutter blade (12) that cuts the grass (26), the drive source (16) that drives the cutter blade, the delivery unit (64) that delivers the grass clippings (34), which are pieces of the grass that has been cut, outside of the mowing range (MR) of the cutter blade, and the carry-in unit (66) that carries the grass clippings that have been delivered outside of the mowing range, into the mowing range. In accordance with such features, the lawn mower that is capable of cutting the grass more efficiently is provided. More specifically, the grass clippings that have been cut by the cutter blade are blown away outside of the mowing range. As the lawn mower moves frontward, the grass clippings that have been blown outside are cut again. In this manner, by cutting the grass twice, the quality of the work, such as the appearance or the like of the lawn after the lawn mowing operation, can be improved.

### (Supplementary Note 30)

In the lawn mower according to Supplementary Note 29, the lawn mower may further comprise the housing including the blade accommodating portion in which the cutter blade is accommodated, and the partition member that partitions the blade accommodation space including the blade accommodating portion from the exterior of the lawn mower, wherein the lower part of the partition member may be open, the delivery unit may include the first opening part (621) formed in the side wall portion (32s) of the partition member, the carry-in unit may include the second opening part (622) formed in the side wall portion, and the first opening part may be positioned frontwardly of the second opening part. In accordance with such features, the delivered grass clippings can be positioned frontwardly of the second opening part.

### (Supplementary Note 31)

In the lawn mower according to Supplementary Note 30, the cutter blade may include the wing portion that is inclined upwardly toward a reverse direction of rotation that is an opposite direction to the direction of rotation of the cutter blade, the first opening part may be positioned above the cutter blade in the vertical direction, and the second opening part may be positioned below the cutter blade in the vertical direction. In accordance with such features, it is possible to cause a suction air flow to be generated that draws in the grass clippings into the blade accommodating portion via the second opening part.

### (Supplementary Note 32)

In the lawn mower according to Supplementary Note 30 or 31, the carry-in unit may further include the suction device (72) that draws in the grass clippings, and the suction device may introduce the drawn in grass clippings into the blade accommodation space via the second opening part. In accordance with such features, it is possible to cause a suction air flow to be generated that draws in the grass clippings into the blade accommodating portion via the second opening part.

### (Supplementary Note 33)

The lawn mower (10) according to the third aspect of the present disclosure comprises the cutter blade (12) that cuts the grass (26), the drive source (16) that drives the cutter blade, and the delivery unit (64) that causes the grass clippings (34), which are pieces of the grass that has been cut, to be moved frontwardly of the mowing range (MR) of the cutter blade. In accordance with such features, the lawn mower that is capable of cutting the grass more efficiently is provided. More specifically, the grass clippings that have been cut by the cutter blade are blown frontwardly or outside of the mowing range. As the lawn mower moves frontward, the grass clippings that have been blown outside are cut again. In this manner, by cutting the grass twice, the quality of the work, such as the appearance or the like of the lawn after the lawn mowing operation, can be improved.

### (Supplementary Note 34)

In the lawn mower according to Supplementary Note 33, the lawn mower may further comprise the housing including the blade accommodating portion in which the cutter blade is accommodated, and the partition member that partitions the blade accommodation space including the blade accommodating portion from the exterior of the lawn mower, and the delivery unit may include the tubular-shaped member (68) that extends frontwardly from the partition member. In accordance with such features, the grass clippings are capable of being suitably delivered frontwardly of the lawn mower.

### (Supplementary Note 35)

The lawn mowing method according to the fourth aspect of the present disclosure comprises the step (S1) of cutting the grass using the cutter blade provided in the lawn mower, the step (S2) of delivering the grass clippings, which are pieces of the grass that has been cut, outside of the mowing range of the cutter blade via the delivery unit, and the step (S3) of carrying the grass clippings that have been delivered outside of the mowing range, into the mowing range by the carry-in unit. In accordance with such features, the lawn mowing method that is capable of cutting the grass more efficiently is provided. More specifically, the grass clippings that have been cut by the cutter blade are blown away outside of the mowing range. As the lawn mower moves frontward, the grass clippings that have been blown outside are cut again. In this manner, by cutting the grass twice, the quality of the work, such as the appearance or the like of the lawn after the lawn mowing operation, can be improved.

Moreover, it should be noted that the present invention is not limited to the disclosure described above, and various configurations can be adopted therein without departing from the essence and gist of the present invention.

1-35. (canceled)

36. A lawn mower, comprising:
a cutter blade configured to cut grass;
a drive source configured to drive the cutter blade; and
a housing including a blade accommodating portion configured to accommodate the cutter blade, and a protruding part configured to project out from the blade accommodating portion in a frontward direction in a frontward/rearward direction with respect to a traveling direction, and configured to communicate with the blade accommodating portion,
wherein the protruding part includes:
a first side wall portion which is positioned on one side of a center line and extends along the frontward/rearward direction, the center line passing through a center of the lawn mower in a leftward/rightward direction orthogonal to the frontward/rearward direction and extending in the frontward/rearward direction; and
a second side wall portion which is positioned on another side of the center line and extends along the frontward/rearward direction,
the lawn mower is a rotary lawn mower in which the cutter blade is disposed rotatably about an axis of rotation,
the first side wall portion is a side wall portion that is positioned further forward than the second side wall portion in a direction of rotation of the cutter blade, and
a maximum dimension of the first side wall portion in the frontward/rearward direction is greater than a dimension of the second side wall portion in the frontward/rearward direction.

37. The lawn mower according to claim 36, wherein:
the housing includes a partition member configured to partition a blade accommodation space including the blade accommodating portion from an exterior of the lawn mower, and the partition member includes an inner wall configured to surround an outer side of the cutter blade in a circumferential direction with respect to the axis of rotation; and
a distance between the axis of rotation and a front end of the protruding part in the frontward/rearward direction is greater than a distance between the axis of rotation and the inner wall in the leftward/rightward direction.

38. The lawn mower according to claim 36, wherein a lower part of the protruding part in an upward/downward direction orthogonal to the frontward/rearward direction is open.

39. The lawn mower according to claim 36, wherein a maximum dimension of the protruding part in the leftward/rightward direction is less than a longitudinal dimension of the cutter blade.

40. The lawn mower according to claim 36, wherein
in one rotation of the cutter blade, a part of the first side wall portion overlaps with a part of the cutter blade when viewed from the leftward/rightward direction, in a state in which a longitudinal direction of the cutter blade coincides with the frontward/rearward direction.

41. The lawn mower according to claim 36, wherein
in one rotation of the cutter blade, a distance between the cutter blade and a rear end of the second side wall portion in the frontward/rearward direction in a state in which the cutter blade and the rear end of the second side wall portion are closest in proximity to each other is greater than a distance between the cutter blade and a rear end of the first side wall portion in the frontward/rearward direction in a state in which the cutter blade and the rear end of the first side wall portion are closest in proximity to each other.

42. The lawn mower according to claim 36, further comprising a rib configured to connect the first side wall portion and the second side wall portion.

43. The lawn mower according to claim 36, wherein a maximum dimension of the protruding part in the frontward/rearward direction is greater than or equal to one third of a longitudinal dimension of the cutter blade.

44. The lawn mower according to claim 36, further comprising a grass dropping tool disposed rearwardly of the housing in the frontward/rearward direction, and configured to drop grass clippings which are pieces of the grass that has been cut and adhere to a grass surface, from the grass surface.

45. The lawn mower according to claim 44, wherein the grass dropping tool includes a plate-shaped member or a brush member.

46. The lawn mower according to claim 44, wherein a lower end of the grass dropping tool is located lower than a lower end of the cutter blade in an upward/downward direction orthogonal to the frontward/rearward direction.

47. The lawn mower according to claim 36, wherein:
the housing includes a partition member configured to partition a blade accommodation space including the blade accommodating portion from an exterior of the lawn mower; and
the lawn mower further comprises a discharge unit disposed at a rear part of the partition member in the frontward/rearward direction, and configured to discharge grass clippings that have been cut by the cutter blade from the blade accommodation space to the exterior of the lawn mower.

48. The lawn mower according to claim 47, wherein the discharge unit includes an opening part configured to allow communication between an inner side and an outer side of the partition member, and a cover member configured to open and close the opening part.

49. The lawn mower according to claim 36, wherein
the cutter blade includes a wing portion that is inclined upwardly toward a reverse direction of rotation that is an opposite direction to the direction of rotation of the cutter blade.

50. The lawn mower according to claim 36, wherein:
the housing includes a partition member configured to partition a blade accommodation space including the blade accommodating portion from an exterior of the lawn mower;
the partition member includes an inner wall configured to surround an outer side of the cutter blade in a circumferential direction with respect to the axis of rotation;
the cutter blade includes a cutting portion provided at least at a portion facing toward the inner wall; and
another protruding part configured to project out from the inner wall toward the axis of rotation is provided on the inner wall.

51. The lawn mower according to claim 50, wherein:
the other protruding part includes a plurality of other protruding parts disposed to be spaced apart from each other in the direction of rotation of the cutter blade; and
a pitch between the other protruding parts that are adjacent to each other in the direction of rotation is greater than a dimension of the cutter blade in the direction of rotation.

52. The lawn mower according to claim 50, further comprising:
a discharge unit disposed at a rear part of the partition member in the frontward/rearward direction, and configured to discharge grass clippings that have been cut by the cutter blade from the blade accommodation space to the exterior of the lawn mower,
wherein the discharge unit includes an opening part configured to allow communication between an inner side and an outer side of the inner wall of the partition member, and a cover member configured to open and close the opening part,
the cover member is provided in a manner so as to form the inner wall in a state of closing the opening part, and
the other protruding part is provided so as to project out from the cover member toward the axis of rotation.

53. The lawn mower according to claim 36, further comprising:
a left wheel and a right wheel that are disposed to be spaced apart from each other in the leftward/rightward direction,
wherein the protruding part overlaps with the left wheel and the right wheel when viewed from the leftward/rightward direction.

54. The lawn mower according to claim 53, wherein a front end of the protruding part in the frontward/rearward direction is disposed more frontwardly than each of front ends of the left wheel and the right wheel in the frontward/rearward direction.

55. The lawn mower according to claim 53, wherein a front end of the protruding part in the frontward/rearward direction is disposed more rearwardly than each of front ends of the left wheel and the right wheel in the frontward/rearward direction.

56. The lawn mower according to claim 53, wherein the left wheel and the right wheel are offset to one side in the leftward/rightward direction with respect to a center line that passes through the center of the lawn mower in the leftward/rightward direction and extends in the frontward/rearward direction.

57. The lawn mower according to claim 36, wherein:
the cutter blade includes a plurality of cutter blades;
the plurality of cutter blades are disposed adjacent to each other in the leftward/rightward direction; and
the protruding part communicates with a plurality of the blade accommodating portions of the plurality of cutter blades.

58. The lawn mower according to claim 36, wherein:
the cutter blade includes a plurality of cutter blades;
the plurality of cutter blades are disposed adjacent to each other in the leftward/rightward direction; and
the protruding part is disposed frontwardly of a plurality of the blade accommodating portions of the plurality of cutter blades in the frontward/rearward direction, and is provided in a manner so as to be disposed to straddle over the plurality of blade accommodating portions in the leftward/rightward direction.

59. The lawn mower according to claim 36, wherein:
the housing includes a partition member configured to partition a blade accommodation space including the blade accommodating portion from an exterior of the lawn mower;
the partition member includes an inner wall configured to surround an outer side of the cutter blade in a circumferential direction with respect to the axis of rotation; and
a flange member configured to project out toward the axis of rotation is provided on a portion of the inner wall that is located below the cutter blade in a vertical direction.

60. The lawn mower according to claim 59, wherein:
the housing includes a reinforcing member configured to be fixed to an outer wall of the partition member; and
the reinforcing member is disposed in a manner so that a lower end of the reinforcing member is positioned below a lower end of the flange member in the vertical direction.
